(19) United States
(12) Patent Application Publication
(10) Pub. No.: US 2016/0307155 A1
(43) Pub. Date: Oct. 20, 2016

(54) ROUTING DEVICE FOR NETWORK OPTIMIZATION

(71) Applicant: GENERAL ELECTRIC COMPANY, SCHENECTADY, NY (US)

(72) Inventor: DAVID BELL, Atlanta, GA (US)

(21) Appl. No.: 15/140,679

(22) Filed: Apr. 28, 2016

Related U.S. Application Data
(63) Continuation-in-part of application No. 14/030,314, filed on Sep. 18, 2013.
(60) Provisional application No. 61/703,795, filed on Sep. 21, 2012.

(51) Int. Cl. G06Q 10/08; G06Q 10/10

(52) U.S. Cl. CPC G06Q 10/08355; G06Q 10/1097

(57) ABSTRACT

A device may create an array of values based on information associated with a plurality of devices, receive information identifying one or more deliverables for routing from a first network address to a second network address in a network, parse scheduling information and the information identifying the one or more deliverables, calculate, based on parsing the scheduling information and the information identifying the one or more deliverables, a value associated with routing the one or more deliverables, use, based on calculating the value associated with routing the one or more deliverables, the array of values to implement an optimization producing a recommended network routing procedure, and transmit, based on implementing the optimization process, the recommended network routing procedure.

### BACKGROUND

1. Technical Field

The subject matter disclosed herein relates to methods and systems for routing deliverables from a first network address to a second network address using a network optimization process.

2. Discussion of Art

Tracking the routing of a deliverable, from a first network address to a second network address, may include the identification of the location of the deliverable at any given time. In addition, the tracking my include identification of the status of the routing of the deliverable, such as sent, received, or the like.

### BRIEF DESCRIPTION

According to some possible implementations, a device for transmitting a network routing procedure based on an optimization process may include a memory configured to store instructions and a processor configured to execute the instructions. The processors may create an array of values based on information associated with a plurality of devices and receive information identifying one or more deliverables for routing from a first network address to a second network address in a network. The processor may parse scheduling information and the information identifying the one or more deliverables and calculate, based on parsing the scheduling information and the information identifying the one or more deliverables, a value associated with routing the one or more deliverables. The processor may use, based on calculating the value associated with routing the one or more deliverables, the array of values to implement the optimization process, the optimization process producing a recommended network routing procedure and transmit, based on implementing the optimization process, the recommended network routing procedure, and the transmitted recommended network routing procedure may be provided, for presentation, on another device.

According to some possible implementations, the array of values may be created using at least one of current location information, forecasted location information, or expected availability information.

According to some possible implementations, the processor may receive information associated with at least one of forecast information or cost information and may use the received information, associated with the at least one of the forecast information or the cost information, to calculate the optimization process.

According to some possible implementations, the processor may modify the scheduling information based on receiving the information identifying one or more deliverables.

According to some possible implementations, the processor may provide, for presentation, information associated with the one or more deliverables, where the information may be associated with the one or more deliverables being provided for presentation in a first display, and additional information, associated with the one or more deliverables, may be provided for presentation in a second display based on a selection operation.

According to some possible implementations, the processor may receive information associated with a movement of the one or more deliverables in the network, may compare the received information associated with the movement to a predetermined criterion, and may transmit, based on the comparing, result information.

According to some possible implementations, the optimization may process analyzes revenue information and cost information, and the optimization process may use the revenue information and the cost information to determine a recommended quantity associated with the one or more deliverables and a recommended type of the one or more deliverables.

According to some possible implementations, a method for transmitting a network routing procedure based on an optimization process may include creating, by a device, an array of values based on information associated with a plurality of devices and receiving, by the device, information identifying one or more deliverables for routing from a first network address to a second network address in a network. The method may include parsing, by the device, scheduling information and the information identifying the one or more deliverables and calculating, by the device and based on parsing the scheduling information and the information identifying the one or more deliverables, a value associated with routing the one or more deliverables. The method may include using, by the device and based on calculating the value associated with routing the one or more deliverables, the array of values to implement the optimization process, the optimization process producing a recommended network routing procedure and transmitting, by the device and based on implementing the optimization process, the recommended network routing procedure, and the transmitted recommended network routing procedure may be provided, for presentation, on another device.

According to some possible implementations, the array of values may be created using at least one of current location information, forecasted location information, or expected availability information.

According to some possible implementations, the method may include receiving information associated with at least one of forecast information or cost information and using the received information, associated with the at least one of the forecast information or the cost information, to calculate the optimization process.

According to some possible implementations, the method may include modifying the scheduling information based on receiving the information identifying one or more deliverables.

According to some possible implementations, the method may include providing, for presentation, information associated with the one or more deliverables, where the information may be associated with the one or more deliverables being provided for presentation in a first display, and additional information, associated with the one or more deliverables, may be provided for presentation in a second display based on a selection operation.

According to some possible implementations, the method may include receiving information associated with a movement of the one or more deliverables in the network, comparing the received information associated with the movement to a predetermined criterion, and transmitting, based on the comparing, result information.

According to some possible implementations, the optimization process may analyze revenue information and cost information, and the optimization process may use the revenue information and the cost information to determine a recommended quantity associated with the one or more deliverables and a recommended type of the one or more deliverables.

According to some possible implementations, a non-transitory computer readable medium may store instructions for transmitting a network routing procedure based on an optimization process which, when executed by a processor of a device, cause the processor to create an array of values based on information associated with a plurality of devices and receive information identifying one or more deliverables for routing from a first network address to a second network address in a network. The instructions may cause the processor to parse scheduling information and the information identifying the one or more deliverables and calculate, based on parsing the scheduling information and the information identifying the one or more deliverables, a value associated with routing the one or more deliverables. The instructions may cause the processor to use, based on calculating the value associated with routing the one or more deliverables, the array of values to implement the optimization process, the optimization process producing a recommended network routing procedure and transmit, based on implementing the optimization process, the recommended network routing procedure, and the transmitted recommended network routing procedure may be provided, for presentation, on another device.

According to some possible implementations, the instructions may further include one or more instructions to receive information associated with at least one of forecast information or cost information and one or more instructions to use the received information, associated with the at least one of the forecast information or the cost information, to calculate the optimization process.

According to some possible implementations, the instructions may further include one or more instructions to modify the scheduling information based on receiving the information identifying one or more deliverables.

According to some possible implementations, the instructions may further include one or more instructions to provide, for presentation, information associated with the one or more deliverables, where the information may be associated with the one or more deliverables being provided for presentation in a first display, and additional information, associated with the one or more deliverables, may be provided for presentation in a second display based on a selection operation.

According to some possible implementations, the instructions may further include one or more instructions to receive information associated with a movement of the one or more deliverables in the network, one or more instructions to compare the received information associated with the movement to a predetermined criterion, and one or more instructions to transmit, based on the comparing, result information.

According to some possible implementations, the optimization process may analyze revenue information and cost information, and the optimization process may use the revenue information and the cost information to determine a recommended quantity associated with the one or more deliverables and a recommended type of the one or more deliverables

### BRIEF DESCRIPTION OF THE DRAWINGS

Reference is made to the accompanying drawings in which particular embodiments of the invention are illustrated as described in more detail in the description below, in which:

FIG. 1 is a schematic block diagram of an exemplary embodiment of a system to visually and graphically manage products, assets, and activities within and between shipper and receiver facilities;

FIGS. 2A and 2B illustrate exemplary embodiments of display screens of a map view of a shipper/receiver facility (“S/R facility”) generated by the system of FIG. 1;

FIG. 3 illustrates a second exemplary embodiment of a display screen of a map view of a transportation route generated by the system of FIG. 1;

FIG. 4 illustrates an exemplary embodiment of a display screen of a plant view of a shipper/receiver facility generated by the system of FIG. 1;

FIGS. 5A and 5B illustrate exemplary embodiments of display screens of a list view of a shipper/receiver facility generated by the system of FIG. 1;

FIGS. 6A and 6B illustrate exemplary embodiments of display screens showing sorting and filtering functionality of the list view of FIGS. 5A and 5B;

FIGS. 7A and 7B illustrate exemplary embodiments of display screens showing the color coding of assets and products in the map view of FIGS. 2A and 2B;

FIG. 8 illustrates an exemplary embodiment of a portion of the string of the display screen of FIG. 4, showing the color coding of the assets and products of the portion;

FIGS. 9A and 9B illustrate exemplary embodiments of display screens showing the color coding of assets and products in the list view of FIGS. 5A and 5B;

FIGS. 10A and 10B illustrate exemplary embodiments of display screens showing a “parking lot” function;

FIG. 11 illustrates an exemplary embodiment of a display screen generated by the system of FIG. 1 showing information associated with providing interchange support of inbound assets (e.g., rail cars) into the S/R facility;

FIG. 12 illustrates an exemplary embodiment of a display screen generated by the system of FIG. 1 showing information associated with loading an asset (e.g., a railcar) within the S/R facility;

FIG. 13 illustrates an exemplary embodiment of a display screen generated by the system of FIG. 1 showing information associated with a product master list;

FIG. 14 illustrates an exemplary embodiment of a display screen generated by the system of FIG. 1 showing information associated with an equipment group master list;

FIG. 15 illustrates an exemplary embodiment of a display screen generated by the system of FIG. 1 showing information associated with an equipment kind master list;

FIG. 16 illustrates an exemplary embodiment of a display screen generated by the system of FIG. 1 showing information associated with a location (e.g., storage area) master list;

FIG. 17 illustrates an exemplary embodiment of a display screen generated by the system of FIG. 1 for the setup of infrastructure (e.g., a plant/track/spot) within the S/R facility;

FIG. 18 illustrates an exemplary embodiment of a display screen generated by the system of FIG. 1 for security and user setup;

FIG. 19 illustrates an exemplary embodiment of a display screen generated by the system of FIG. 1 for a color scheme setup; and

FIGS. 20-35 illustrate exemplary embodiments of display screens of the system.

### DETAILED DESCRIPTION

The subject matter disclosed herein relates to methods and systems for managing assets, products, storage, and transportation within and between shipping and receiving facilities of a shipper or a receiver. Embodiments of the invention relate to methods and systems providing displayed representations and a graphical interface for managing products and assets within and between shipping and receiving facilities such as plants, yards, ports, and warehouses.

Some shippers may be concerned with a production process and where to place a product after it has been produced. For example, produced material may be in the form of bulk product (e.g., chemicals) and may be placed in a storage container. Some shippers use rail cars as storage containers in addition to other transportation vehicles. Therefore, when material is produced, a shipper may ensure that rail cars are present to accept the product. A shipper may desire to keep track of product inventory in the shipper facility to support dispatching product out to customers and may further desire to track the product all the way to its destination point during shipping to a customer (e.g., a receiver).

Receivers are concerned with inventory and knowing how much product is on hand and how many days of production can be supported. Receivers are also concerned with inbound deliveries of materials and product including how much product is on its way, how far away the product is, and how many days out the product is. A shipper or receiver works closely with, for example, a rail carrier such that product ends up where it is supposed to be on time. In accordance with an embodiment, communication between a shipper or receiver and a rail carrier takes place via electronic data interchange (EDI) communications.

As used herein, a “product” may refer to materials provided by an entity to a consumer. Products may be produced (e.g., manufactured from other inputs) or distributed without modification. Thus, with respect to a single entity, a product may be what the entity sells or exchanges for value in return. A product may be any material or good that may be transported. A material may include an input used in a product, or other matter incident to production or operation of a facility. Products and/or materials may be combined, blended, mixed, and so forth, in various schemes (e.g., loaded on the same asset but boxed differently, loaded on the same asset but easily segregated as with chunks of ore and large logs, loaded on same asset and mixed, as with different ores that may be combined in an alloy, and so forth). A product may be a material or vice-versa to different entities within a supply chain or within the same entity. An “inventory” may be a quantity of product, material, or other matter. An inventory refers to an amount in a facility, but may also include amounts throughout an entity or enterprise, or amounts that may be otherwise available for the purposes of the inventory (e.g., for production, for sale to consumers, and others). There may be inventories of other items (e.g., assets).

Products, inventories, and other aspects may exist (e.g., as a discrete item, in particular quantities) at locations (e.g., within a plant, on tracks between buildings, in a truck between a shipper and a receiver). Locations may be absolute (e.g., latitude/longitude value), relative (e.g., located at a known position in a plant), and/or combinations thereof. Products, inventories, and other aspects may be repositioned, resulting in their location being changed. Repositioning may be effected, for example, to stage products for use or shipment, to prioritize or order a plurality of inventories, to create space for other products or the performance of tasks, and other reasons.

The term “shipper” refers to an entity in the business of shipping products via some form of transportation (e.g., via trucks in an on-highway fleet or rail cars on a railroad). A shipper may be in the business of producing, mining, or processing the product (e.g., coal) to be shipped. The term “receiver” refers to an entity in the business of receiving products from shippers via some form of transportation (e.g., via tractor trailers). A receiver may or may not also be in the business of using or further processing the product (e.g., plastic pellets).

The terms “container” and “trailer” refer to a storage medium or area configured to hold products, goods, or other shippable or receivable materials. These aspects may be examples of “assets.” The term “shipper or receiver (S/R) facility” refers to a facility, location, site, or area where products and assets may be managed. The term “S/R facility” may be used to refer to a facility of a shipper, a receiver, or both. The managing of products and assets may include, for example, moving, loading, unloading, storing, stacking, linking, assigning, shipping, and receiving the products and assets. The term “asset” refers to anything that may be managed in the S/R facility or between S/R facilities. Examples of assets include, but are not limited to, rail cars; ships; other shipping transportation vehicles; storage containers or storage areas for storing products or assets; containers/trailers that may be loaded/unloaded with product and loaded/unloaded from rail cars, ships, or other shipping transportation vehicles; or transportation vehicles for moving, loading, and unloading products within the S/R facility. When in use in support of or assigned to an order, maintenance, et cetera, at least a portion of an asset may be non-available (e.g., cannot be assigned for that time period to another order).

Assets may be operated by one or more entities, meaning a particular entity owns, possesses, uses, conveys, maintains, performs, or may be responsible for various other aspects related to one or more assets. A “private asset” as used herein may be an asset owned or operated by a third party other than the shipper. A “private fleet” may be a fleet of assets owned or operated by the third party.

As with products and inventories, assets may have locations, and may be repositioned between locations. Assets may be “released” to other entities, which may refer to the administrative process(es) used to provide possession of an asset to an entity that may perform a function involving the asset (e.g., conveyance, maintenance, loading). Alternatively, releasing may refer to permission or conditions set to advance through a workflow or an order fulfillment (e.g., released from shipper to depart for receiver).

As used herein, an “asset class” may be one or more assets associated with one or more characteristics. For example, rail cars may be an asset class among all assets, and tanker railcars may be an asset class (or sub-class) among railcars. In embodiments, an asset class refers to all assets sharing one or more characteristics. In embodiments, an asset class refers to a particular model of identical assets. In embodiments, a single asset may belong to two or more classes or sub-classes.

Assets may relate to target and/or maximum daily asset loadings. A target daily asset loading may relate to optimal, minimum, or “non-exigent” (e.g., barring unusual circumstances) maximum loadings for assets. Loading may be measured in numbers of assets or products, and there may be target loadings for particular classes of assets, or assets may be weighted or treated differently in a composite target loading. A maximum daily loading may be a number which should not be exceeded with respect to assets related to a facility, enterprise, or a subset thereof.

Assets may have modifying terms associated with them. For example, for an asset may be owned by a shipper, the shipper may abide various governmental or third party regulations that may be supplemented with internal policies, support or warranty guidance, and other aspects. Alternatively, assets may be owned by a third party who may lease, rent, finance, lend, et cetera, one or more assets to a shipper. Various contract terms related to uses, maintenance and tax liabilities, other associated entities (e.g., repair shops), routes used, and so forth may govern the use of assets. An asset's actual use may be what may be actually done with the asset, and may be in fulfillment or violation of the asset terms.

As used herein, an “entity” may be any individual, group, or business involved in the transfer of materials. In embodiments, entities may belong to or control other entities (e.g., as in parents and/or subsidiaries). If two or more entities may be discussed, the two entities represent distinct parties not sharing all resources such that some exchange occurs when resources transfer from one entity to the other. While this refers to some combination of products, materials, and money flowing between the two entities according to valuation of portions of the combination in terms of other portions of the combination, it may be appreciated that various other incentives (e.g., development of goodwill, sampling, and others) and/or deferment of a portion of a deal (e.g., consignment, exchange, advance credit, and others) may be involved in the exchange. As used herein, a “consumer” may be an entity that consumes or utilizes a product from an upstream entity. Other examples of entities herein may include (but may be not limited to) shippers, receivers, producers, private fleets and/or private fleet managers, repair shops and/or other business entities related to some aspect of transactions, and others.

As alluded to above, a “transfer” may include any movement of product, material, asset, and/or other matter. While transfers may be described in terms of external exchanges between entities, it may be to be appreciated that transfers may occur within a single entity (e.g., material transferred from one asset to another, from one location to another, from one business to another, and so forth). Transfers between a single entity may occur, for example, to facilitate production, efficient utilization of assets or space, staging for an outgoing shipment, to accommodate an incoming shipment, and other reasons. Multiple transfers and re-transfers may be cognized under the singular “transfer,” such as when a material may be conveyed through multiple points or nodes within one or more entities before being utilized in whole or part.

As used herein, an “order” may include a request for one or more products and/or materials. An order may be fulfilled or completed through (or may otherwise be related to) one or more exchanges or transactions between two or more entities. In embodiments, an order may be completed through (or may otherwise be related to) one or more exchanges or transactions within a single entity (e.g., between business units, between facilities, for accounting purposes, and so forth). One or more order statuses may be associated with an order. Order statuses may include information relevant or of interest to any entity with interest or involvement in the order, such as exchange amounts (e.g., product/material quantities, money for product/material, other fees), shipment timing, delivery timing, payment timing, assets associated with the order, and others. Order statuses may be updated based on processing or fulfillment. For example, order statuses may be updated to indicate an order has been received, an order has been forwarded for fulfillment, at least a portion of the order may be being fulfilled (e.g., being picked or loaded), at least a portion of the order may be shipped, at least a portion of the order may be fulfilled, and so forth. Order status updates may refer to a specific portion or parties related to the portion (e.g., a particular line involved with a particular product) or the order at large. These examples may be to be construed as providing non-exhaustive details related to the spirit of order statuses (and orders), and other details or status information may be provided herein.

Orders may be scheduled, such that they may be planned for fulfillment and at least one instruction or resource may be in place to the accomplishment of such ends. Sets of orders may be scheduled to manage a plurality of orders and de-conflict (e.g., ensure no aspects related to the order such as product quantities or assets may be being used in support of another order, may be assigned to be used in support of another order during a period of time, or may be otherwise unavailable) the resources or prioritize instructions. New orders may be received and added to the sets or schedules, resulting in various adjustments to the new order, other orders, sets, or schedules.

The term “workflow” may be a progression of aspects to accomplish an end. For example, a workflow to deliver one or more products may include production, preparation, and shipment. Each aspect may in turn be its own workflow. For example, production may include determining a production quantity, preparing the raw materials, scheduling labor and equipment, and creating the product. Put another way, a workflow may include one or more tasks, and tasks may include sub-tasks or aggregate to a larger task. Workflows may facilitate the flow of material (and/or information) or task accomplishment in a way that minimizes delay or inefficient use of resources. Workflows may have times associated, such as a previous, average, or predicted time to complete a workflow or portion thereof. Tasks may have times associated, and may be added to determine a workflow time based on the tasks. Workflows may have associated workflow lists that provide a listing of necessary tasks or aspects, and may also (but need not) provide details concerning their relationships, scheduling, and management. “Workload” may indicate aggregate workflow aspects, tasks, or other requirements on an entity or subsets thereof.

Orders (and workflows or tasks that relate to one or more orders) may have costs associated. For example, the time, labor, assets, bandwidth, fuel, and other costs associated with a shipper may be directly attributed to orders or averaged across orders. Thus, both direct and indirect costs may be associated with an order. In embodiments, different means of fulfilling an order (e.g., different time frames, different routes, different loading combinations, different assets, and so forth) may result in different costs associated with the order. Order schedules (including, e.g., assets to be used, routes, timing, and so forth) may be planned or modified in view of costs, including changes to costs based on new or fulfilled orders. Particularly, an order-asset cost may be one or more costs associated with fulfilling an order based on the asset used.

Revenues may also be considered in aspects herein. Revenues may be amounts generated or received based on the sale of goods (e.g., a product itself) or services (e.g., shipment of the product), or through other means. An order-asset revenue may be an amount of revenue generated based on an order fulfilled at least in part by an asset. Order-asset revenue may change based on the asset selected.

Related to aspects described may be one or more shipping solutions, which may include details for fulfilling an order. A shipping solution involves associating one or more assets from a set of assets with at least one order from a set of orders to fulfill the set of orders in accordance with a shipping schedule. The shipping solution may not be complete until relevant products/materials, assets, resources, workflows, et cetera, may be reserved and de-conflicted with other shipping solutions.

Similarly, a shipping plan may be a plan or aspects to fulfill one or more orders based on costs and assets. In embodiments, a shipping plan may include scheduling one or more orders.

As used herein, production may be the creation of a product or other process adding value for a downstream or other consumer, but need not be limited to such exclusive definition. For example, in some services, “production” may be invoked to refer to the portion of a unit that works for or supports entities outside the unit, and may drive the unit's value by providing quid pro quo to various entities. A production schedule may be the timing related to the occurrence of production, as well as requirements incident to production (e.g., asset availability, labor, maintenance, and others). Various schedules related to production or other aspects. may be described. In embodiments, a production schedule, or other schedule, may be based on a customer schedule. A customer schedule may be based on customer expectations and/or requirements. For example, a customer schedule may be a time at which the customer may expect to receive a product, a time at which the customer may be prepared to receive a product, a time the product may be in accordance with the customer's production or shipment schedule, and others. Order schedules may be schedules including a time of order receipt, projected or actual ship time, projected or actual receipt time, and so forth.

As used herein, an “equipment availability matrix” may be at least a text- or graphics-based informational display that may indicate times of equipment (including assets) availability or non-availability. For example, when an asset may be assigned to an order and scheduled to ship, the asset may be non-available at least until the order may be projected to be complete, and may be non-available until the asset may return from its trip, be serviced or re-fitted, et cetera. Equipment availability matrices may be based on actual times (current or historical), average times, predicted times, others, and combinations thereof.

As used herein, a “map” may be a visual representation of space in a two-dimensional rendering.

As used herein, visual characteristics may include the aesthetic and/or functional aspects of appearance in an interface or other aspects. While color-coding may be discussed herein, other aspects such as icons, including the shape, size, opacity, et cetera thereof may indicate particular information. Various icons/images, text, and other symbols may be included in one or more aspects including visual characteristics. Visual characteristics may blend disparate sources to composite images (e.g., cartoon-like icons superimposed over satellite or ground-based photos of facilities or portions thereof) or be uniform in appearance (e.g., wholly computer-generated imagery). Further, other sensory information (e.g., sounds, tactile information) may be utilized in combination with or as a substitution for various visual characteristics.

“Software” or “computer program” as used herein includes computer readable and/or executable instructions, stored in a non-transitory computer-readable medium, that cause a controller or other electronic device to perform designated functions, designated actions, and/or behave in a desired manner. The instructions may be embodied in various forms such as routines, algorithms, modules or programs including separate applications or code from dynamically linked libraries. Software may also be implemented in various forms such as a stand-alone program, a function call, a servlet, an applet, an application, instructions stored in a memory, part of an operating system or other type of executable instructions. It will be appreciated by one of ordinary skill in the art that the form of software may be dependent on, for example, requirements of a desired application, the environment it runs on, and/or the desires of a designer/programmer or the like.

“Computer” or “processing element” or “computer device” as used herein includes, but may be not limited to, any programmed or programmable electronic device that may store, retrieve, and process data. “Non-transitory computer-readable media” include, but may be not limited to, a CD-ROM, a removable flash memory card, a hard disk drive, a magnetic tape, and a floppy disk. “Computer memory”, as used herein, refers to a storage device configured to store digital data or information which may be retrieved by a computer or processing element. “Controller”, as used herein, refers to the circuits/circuitry, logic circuits/circuitry and/or processing elements, possibly including associated software or program(s) stored in a non-transitory computer-readable medium, that is configured for the managing of assets and products associated with the S/R facility as set forth herein. The terms “signal”, “data”, and “information” may be used interchangeably herein and may refer to digital or analog forms. The term “communication device” as used herein may refer to any wired or wireless device (e.g., a computer modem) operable to receive and/or transmit signals, data, or information. The term “virtual” as used herein refers to the simulation of real world objects and characteristics in a computer environment. As used herein, a “module” may be a computer-related component (e.g., software, hardware, combinations thereof, and so forth) providing at least the described functionality. For example, a module may be a software application, a portion of a software application, and electronic device, and others.

Some of the systems and methods described herein may be discussed in the context of shippers and receivers using rail cars and railroad transportation. However, embodiments of the invention may apply equally well to other types of shippers and receivers using other types of transportation such as, for example, port entities using sea-going vessels, mining equipment, on-road trucks, and the like.

In one embodiment, a system may monitor vehicle and container dwell times. Monitoring dwell time may allow control that influences productivity, may reduce or eliminate demurrage charges, may capture vehicle or container inspection information, may report vehicle or container status, may capture a characteristic parameter relating to a product or group of products or an asset or group of assets, and may pre-block vehicles and containers for efficient hand off to an operator or carrier. Vehicles and containers may be pre-blocked according to a destination or other parameter. For example, a railway train may have a pre-defined number of blocks, and a shipper may communicate with a rail carrier to assemble a block of cars to fill a block in the train.

An embodiment of the present invention provides functionality associated with fleet optimization. The fleet optimization functionality may be implemented as a separate fleet optimization application or as a fleet optimization module which is part of a shipper/receiver management software application (SRMSA) application, in accordance with various embodiments. The fleet optimization functionality is configured to determine an optimized shipping schedule for a set of orders that maximizes a shipper's profitability by, at least in part, minimizing transportation costs. A shipper may have one or more locations from which they ship product, in addition to one or more customer locations (receivers) where the product is delivered. There can be a myriad of choices and a complex matrix of costs that the shipper may encounter when making decisions about the “best” way to deliver product to customers. Some of these choices can include the cost of using railroad cars compared to the cost of using a private fleet (owned or leased cars) of the shipper, maintenance costs of the private fleet, and costs associated with shipping product on various routes between a shipper location and a customer location. The fleet optimization functionality allows a user to navigate the cost complexity and make decisions that are optimal for shipper profitability. For example, a particular mix of private rail cars and railroad owned rail cars may be employed to maximize profitability. Based at least in part on the shipping schedule, a machine may be controlled to ship at least one product of a new order.

In accordance with an embodiment, the fleet optimization functionality can include aspects related to shipment inputs, rail track and trace (RTT) integration, and the optimization model which determines the “best” shipping plan. With respect to shipping inputs, the shipper may enter, via a user interface of the system, the various products which can be shipped, the location of the facilities where the products are shipped from, the names and locations of the customers, the rail cars on which product may be shipped, and orders to be fulfilled. Real time statistical information on rail car unloading times at customer locations and transit times between shipper and customer locations may be leveraged by integrating the fleet optimization application with one or more other related applications (e.g., a rail track and trace application). In addition, real time information may be provided on the location and destination of the shipper's private fleet of rail cars. In this manner, the fleet optimization application can “know” which rail cars are likely to be available and when. The rail cars can be tracked throughout their journey and computations can be made as to when the rail cars will return back to the S/R facility to be reloaded with product.

In accordance with an embodiment, an integrated optimization algorithm can produce a recommended shipment plan that maximizes the overall profitability to be gained from a set of potential shipments over a selected planning period. The optimization process can analyze the potential gross revenue for the planned shipments based on available rail cars and determines an optimal mix of private vs. railroad owned equipment to use. The process can additionally assign assets to each of the planned shipments after considering equipment availability, applicable freight rates, transit times, customer dwell, repositioning/maintenance costs, et cetera. In accordance with an embodiment, the optimization algorithm may act as a customer interface, sending inputs and receiving optimization output results.

The optimization process may recommend that the shipper delay, decline, or transfer fulfillment of one order in favor of fulfilling another order first. Therefore, a shipper (or software) may select which orders to fulfill first and the amount of product to be loaded or supplied in each order to maximize total profitability of all the orders. The optimization process can analyze the revenue that can be earned for a particular order and the costs associated with that order (e.g., transportation related costs) and can recommend how much product to supply to each order to maximize overall profitability, in accordance with an embodiment. Furthermore, the optimization process may tell a user one or more types of products to load into one or more types of rail cars to maximize the amount or product shipped such that a maximum percentage or ratio of the rail car's capacity is used.

An optimization pre-processing functionality may create a matrix of equipment availability based on the current location of private rail cars available for loading, the forecasted availability of private equipment currently en route based on transit time and customer dwell estimates, potential repositioning movements, and the expected availability of railroad owned equipment. Such an equipment availability matrix may be provided to the optimization algorithm (and/or users) along with the shipments forecast and associated revenue, and/or various cost components. Based on such inputs, the optimization process may create a recommended shipment plan that maximizes overall profitability for the planning period.

The process for setting up locations where the shipper originates product may require a shipper to enter a target and maximum number of rail cars that can be loaded and shipped each day of the week. An organization (or subset thereof) can seek to fulfill orders without exceeding the target number of rail cars. However, if the orders cannot be fulfilled without exceeding the target number of rail cars, the optimization may not produce a result that requires more than the maximum number of rail cars for the given day of the week. In embodiments, other arrangements can be based on alternative constraints.

Rail cars may be organized into groups of (organization-owned or operated) railroad cars and private cars. For each order, the user may assign the rail car group(s) that can be used to fulfill the order. Within a rail car group, all rail cars may be treated the same. The individual rail cars within the group may have different volumetric capacities. However, the optimization process may use the volumetric capacity assigned to the group. Alternatively, one or more aspects of a module or modules can value each asset separately. Additionally, private rail cars within a group may have different per-day or per-mile maintenance costs. However, the optimization process may use the per-day and per-mile maintenance costs assigned to the group.

Products may be assigned a density, rail car groups may be assigned a volumetric capacity, and order quantities may be specified in terms of weight. To determine the number of rail cars that are required to ship an order, the weight of the order is divided by the density (e.g., of each respective product, an average of products, and others) to determine the volume of material that is ordered. Subsequently, an optimal type and number of cars required to ship the order can be determined by using the volumetric capacity assigned to each rail car group.

There may be many routes that can be used to ship product between a shipper's facility and a customer location (receiver facility). Each route can have costs for railroad cars and private cars associated with it. A railroad may provide a discount to a shipper for agreeing to use a particular route (e.g., agree to ship 90% of shipments on this railroad over that particular route in return for a discounted cost of a particular amount). The optimization algorithm can determine which route is optimal (e.g., maximum revenue, minimum costs, maximum profit, fastest arrivals) for each shipment with respect to profitability.

Each order can specify the quantity of the ordered material. However, in some cases, it may not be possible to ship the entire quantity ordered in a given period. For example, a shipper may have more orders than it can fulfill with the rail cars available, or it may have orders for more product than it can produce. To handle this scenario, the optimization process can use embedded logic to ensure that profitability is maximized given the constraints and based on various projected quantities (e.g., production, asset availability, and others).

In accordance with embodiments, the output of the optimization process is a shipping plan that details a specific mix of private rail cars and railroad rail cars to be used for each shipment, as well as the time to be shipped based on expected equipment availability. Additionally, for customers with more than one shipping facility, the optimization process may provide plan detailing where each private car needs to be repositioned after unloading.

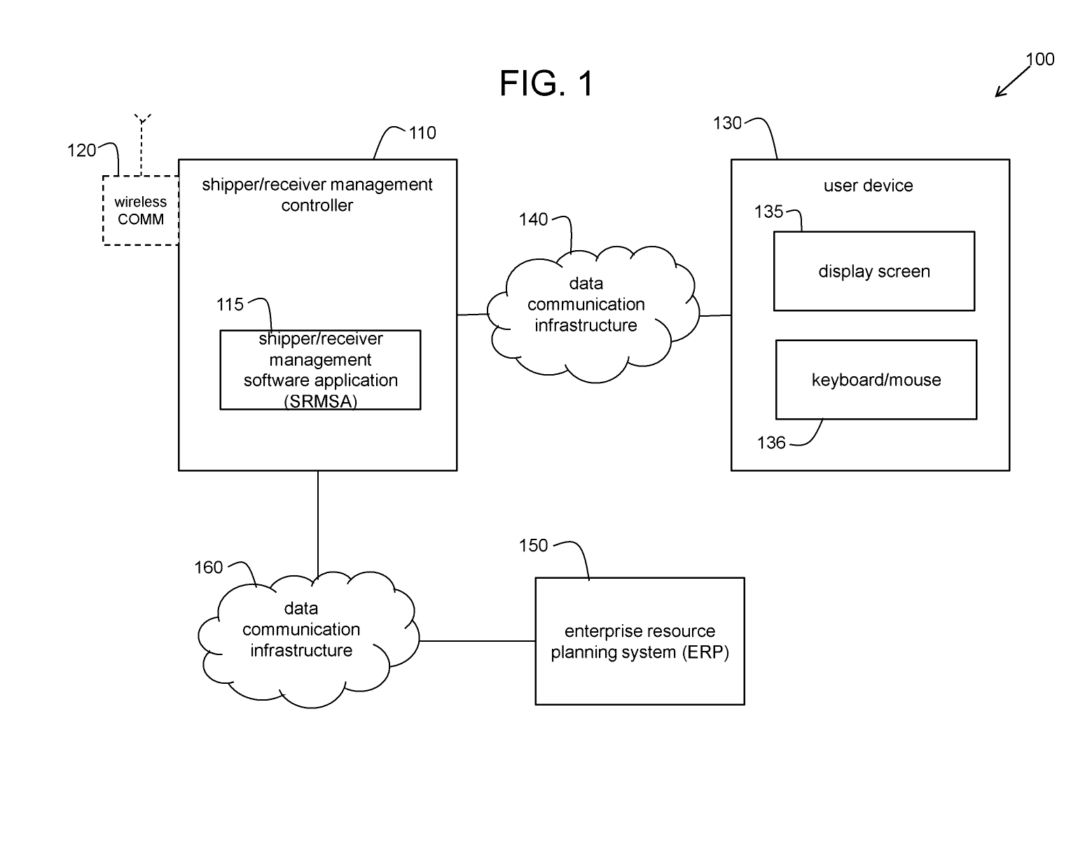

Turning now to FIG. 1, illustrated is a schematic block diagram of an exemplary embodiment of a system 100 to visually and graphically manage products, assets, and activities within and between S/R facilities. The S/R facility may be, for example a plant, a yard, a port, a warehouse, or a lot or any location and/or facility where products and assets are managed (e.g., moving, loading, unloading, storing, stacking, linking, assigning, shipping, and receiving the assets and products). Assets associated with a S/R facility may be loaded or unloaded with product at the S/R facility. Embodiments of the invention provide functionality associated with the loading/unloading process and provide integration to the enterprise resource planning system (ERP) of a shipper or receiver.

The system may include at least one shipper/receiver management controller 110 operable to manage products, assets, transactions, and activities taking place within the S/R facility. The controller 110 is operable to control a displayed representation of the S/R facility and products and assets located in the S/R facility, along with characteristics of the products and assets. Selectable options may facilitate managing the products and assets within the S/R facility through a graphical interface. Functionality allowing interfacing with an entity that delivers assets (e.g., rail cars) to the S/R facility may be provided. For example, the system may respond to a vehicle or container being ready for dispatch by initiating an electronic data interchange (EDI) request. The request may instruct a carrier to come and get the vehicle or container from a shipper's facility. Similarly, if the carrier holds a container for a shipper the EDI request may be made instructing the carrier to deliver the container to the shipper's facility. Integrated inbound and outbound asset and product visibility may be provided, along with automation of key tasks and production of work orders for train crews.

In one embodiment, the S/R management controller 110 may be implemented as a computer server running a shipper/receiver management software application (SRMSA) 115. The S/R management controller may manage products and assets within the S/R facility (e.g., the assignment, loading, unloading, and movement of products and assets within the S/R facility), and may provide a graphical mapping that allows visualization of the S/R facility by a user on a display screen. The S/R management controller may provide a graphical mapping that supports visualization of transportation assets, having product loaded thereon, in transit (en route) between S/R facilities along with estimated times of arrival.

As an option, the system may include a wireless communication (COMM) device 120 operably interfacing to the controller and able to communicate with other wireless devices (e.g., via radio frequency communication) operating within the S/R facility. Such other wireless devices may be hand-held devices used by inspectors, or may be located in on-site transportation vehicles within the S/R facility.

The system may include a user device 130 (e.g., a desktop personal computer, a hand-held tablet computer, or a mobile telephone) having a user interface including a display screen 135 (e.g., a touchscreen display) and, optionally, a keyboard and/or a mouse 136. The user device may communicate with the S/R management controller either directly or via a data communication infrastructure 140 (e.g., a computer network). The user device may be located in an office on site at the S/R facility, or may be remotely located away from the S/R facility. In accordance with an embodiment, the user device may be a mobile, wireless, touch-screen, hand-held device that may be used by a user as the user walks or drives around the S/R facility (e.g., if the user is part of a maintenance crew). The system may provide a directional locator function, directing a user to a product or asset within the S/R zone that may be selected by the user.

The system may include an enterprise resource planning system (ERP) 150 in operative communication with the S/R management controller 110 via, for example, a data communication infrastructure 160 (e.g., the internet). The ERP 150 may be configured to manage various aspects (e.g., scheduling, tracking, way billing, revenue accounting) of a larger enterprise such as, for example, an entire shipping company having multiple S/R facilities. Therefore, the ERP 150 may communicate with a plurality of S/R management controllers at a plurality of S/R facilities of a shipper or receiver.

If the S/R management controller is on site at the S/R facility, the user device may communicate in a direct wired manner with the controller, or via a data communication infrastructure that may be a local area network. If the S/R management controller is remotely located from the S/R facility, then communication with the user device may be via a larger network, such as the internet. For example, the S/R management controller may be co-located with or be implemented on a same server computer as the ERP 150. As another example, the S/R management controller may be hosted at a third party site (e.g., a provider of the SRMSA) as a software-as-a-service (SaaS) configuration. As a further example, the data communication infrastructures may be the same network (e.g., the internet). Other configurations may be possible as well, in accordance with various other embodiments.

Shipping vehicles may be located throughout the S/R facility, may be loaded or unloaded, and may or may not be linked to a block of, e.g., rail cars to be moved by one or more locomotives of a railroad as a train. In one embodiment, the system provides a graphical interface on a display screen of the user device allowing a user to manage products and assets in the S/R facility. A user may interact with the S/R management controller via the user interface device to configure the layout of the S/R facility and tracks, paths, or other asset routes within the S/R facility, for example. The resultant configuration may reflect the current state of the S/R facility, or may reflect a desired state of the S/R facility to be implemented, or may represent both (e.g., using different visual style elements).

A user may then view the location of assets on asset routes (e.g., rail cars on tracks) within the S/R facility, check the status of a vehicle or container or other asset, update (move) the location of the vehicle or container or other asset within the S/R facility, and review or enter transportation (e.g., waybill/Bill of Lading) information for the vehicle, container, or other asset. A user may create if-then logic to help plan and manage asset movements within the S/R facility. Checking the status of the asset may involve, for example, checking if a car is loaded and with what product or commodity, checking the identity of the receiver of the loaded commodity, checking the assigned destination of the vehicle or container or other asset, and checking the owner (or lessor) of the vehicle or container or other asset. Waybill information for the asset may be checked and Bill of Lading information entered using the system of FIG. 1. In one embodiment, the user device may be used to verify tracking information physically associated with the asset, such as a radio-frequency identification (RFID) or automatic equipment identification (AEI) tag, or a barcode, or the like. That user device might scan the associated indicia and match it against the status information. The user may make updates or corrections to errors on the spot.

A method is provided in one embodiment that includes obtaining shipping or receiving information associated with products and assets located within the S/R facility. The obtained shipping or receiving information may be processed for the generation of displayed graphical representations of the products and assets located within the S/R facility. This may be done along with characteristics of the products and assets. Selectable options may be then provided to a user for reviewing and editing the shipping or receiving information.

The obtained shipping or receiving information may be processed for the generation of displayed graphical representations of the products and assets en route (in transit) between two or more S/R facilities. The processed shipping information may be passed to others, such as carriers, to facilitate transportation services. This information passing may be done, for example, via EDI communications. The graphical representations may be displayed as graphical icons and/or text information. The shipping or receiving information may be obtained from an enterprise resource planning system and may include Bill of Lading or waybill information. An analytic “dashboard” may provide status overviews on planning and productivity measures. Configurable role-based views may allow a user to make strategic decisions to manage upcoming work, optimize capacity, and reduce operating costs.

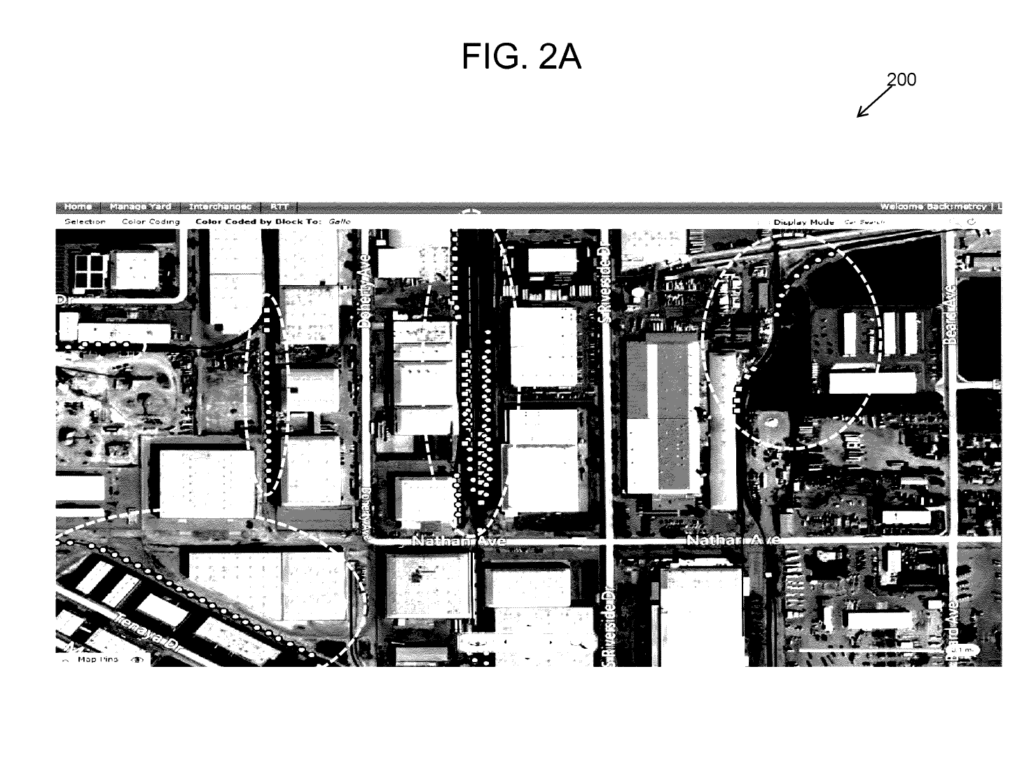

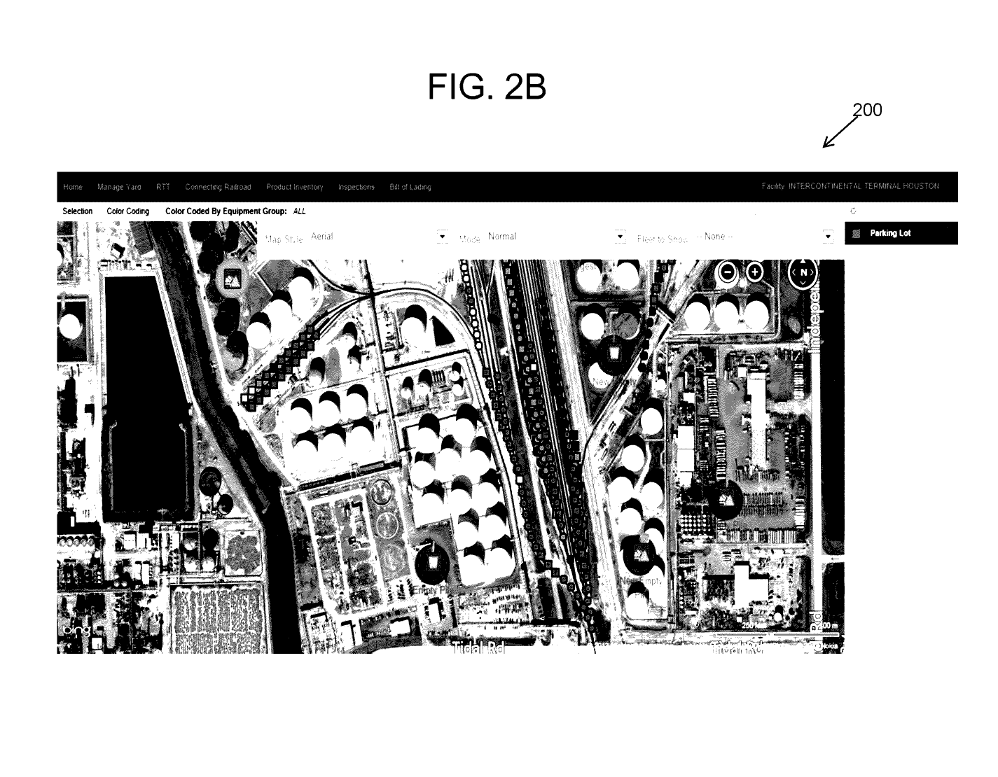

FIGS. 2A and 2B illustrate two views of at least a first exemplary embodiment of a displayed graphical representation(s) 200 of the S/R facility provided by the system of FIG. 1, e.g., the user device 130 may be configured to display the graphical representation(s) 200 on the display screen 135. The graphical representation may comprise an aerial view (top down view) of the S/R facility. The aerial view may be a map (i.e., map view) of the S/R facility, or it may be an aerial photographic view (such as a satellite view, as in FIGS. 2A and 2B) of the S/R facility, or it may combine elements of the two, e.g., an aerial photographic view overlaid with displayed map elements to highlight portions of the aerial photographic view. (The system may be configured to modify the aerial photographic view of the S/R facility, to remove non-static elements of the photographic view that may change in actuality between when the photographic view was generated and when it is displayed in the system. For example, unless the photographic view is generated in real time or otherwise regularly periodically generated (which it is in embodiments), vehicles captured in the photographic view may have been moved by the time the photographic view is displayed for use. Thus, such vehicles captured in the photographic view may be removed from the view, leaving only the static infrastructure of the S/R facility in the view.) The aerial view may include displayed graphical representations of one or more asset routes of the S/R facility. For example, if the S/R facility includes one or more railroad tracks linked to an external rail transportation network or otherwise, the aerial photographic view may include displayed graphical representations of the one or more railroad tracks. In another example, if the S/R facility includes one or more roads linked to an external highway network or other road network or otherwise, the aerial photographic view may include displayed graphical representations of the one or more roads.

In embodiments, the system is also configured to display asset information (e.g., rail car information and storage area information) and/or product information (e.g., raw material information) as part of and/or in conjunction with the displayed graphical representations of the S/R facility. For example, the system may be configured to display the asset information and/or the product information as icons overlaid on the displayed aerial view of the S/R facility. Examples are shown in FIGS. 2A and 2B—see the icons indicated with the regions of the dashed white circles of FIG. 2A, and similar icons on FIG. 2B. The icons provide cues and/or information about the status and/or locations of assets and/or products, which may include an asset identification (ID) code, a loaded product type, product availability, product amount, a destination, an origin, a container type, asset health, equipment status, maintenance status, and/or load status.

In one embodiment, for an S/R facility that includes one or more asset routes and where the assets are vehicles and/or shipping containers transported by vehicles, the system may be configured to display a graphical representation of the S/R facility as an aerial view, including representations of the asset routes, and graphical representations of the vehicles and/or shipping containers overlaid on the aerial view in relation to the asset routes. For example the displayed graphical representations of the vehicles and/or shipping containers may be positioned with respect to the displayed asset routes in correspondence with actual locations of the vehicles and/or shipping containers relative to the asset routes in the S/R facility. The correspondence may be exact, such as exact positions of the vehicles and/or shipping containers as determined via GPS or other sensors, or it may be approximate, such as the graphical representations of the vehicles and/or shipping containers being displayed in general association, and not necessarily exactly located, with a particular section of displayed asset route. For example, for railcars on a siding, it may be sufficient merely to show the railcars on the siding, and without exact positions of the railcars.

As indicated, some S/R facilities may include railroad tracks as asset routes, and the assets may be railcars and/or shipping containers carried by railcars. For such S/R facilities, the system may be configured to display a graphical representation of the S/R facility as an aerial view, including displayed graphical representations of the railroad tracks, and graphical representations of the railcars and/or shipping containers overlaid on the aerial view in relation to the displayed graphical representations of the railroad tracks.

In embodiments, the displayed graphical representation of the S/R facility (aerial view or otherwise) includes displayed infrastructure of the S/R facility other than asset routes, assets, and products of the S/R facility. For example, the displayed graphical representation of the S/R facility may include displayed graphical representations of buildings of the S/R facility, storage tanks and other infrastructure that hold products, waterways and other bodies of water, vegetation, and infrastructure not directly associated with S/R facility, e.g., roadways and buildings that are adjacent the S/R facility but not part of the S/R facility.

The system may be configured to generate a displayed “refresh” icon. The refresh icon allows a user to update the displayed graphical representation to show the current inventory (products and assets) in the facility as overlaid icons (e.g., see the overlaid icons within the dashed ovals of FIG. 2A). Also, the inventory (and associated information) may be automatically updated on a determined schedule. The updated information may be received by the controller from the ERP 150, in accordance with an embodiment, and processed by the SRMSA 115 to refresh the view on the display screen 135 of the user device 130.

The system may be configured for a user to also mark locations in the map view using marker points. A marker point is a point of interest on the map view that is selected by the user, which stays fixed until cleared by the user, and which may act as a reference point in the system for performance of one or more functions of the system. Such functions may include map zoom-in (i.e., generate an enlarged view of the aerial view) and zoom-out (i.e., generate a reduced view of the aerial view), e.g., zoom-in or zoom-out is carried out with reference to the marker point, and view indexing, e.g., if the user switches to another view and then returns to the view with the marker point, the view with the marker point is centered on the marker point, and/or the system may be configured to display a list of the extant maker points for switching between the views of the marker points based on user selection of the marker points in the list. The system may be configured to designate the marker points using displayed graphical representations, such as displayed graphical representations of pins (that is, an element displayed on the display that resembles a pushpin). In an embodiment, the system is configured so that when a marker point is designated by a user (e.g., a pin is placed), the system zooms in on the “pinned” location where the user desires to work. To add a new pin, a user may click on an “Add Pin” icon of the window and then click on the location to be pinned. An “Add Pin” pop-up window may appear and the user may enter a name for the pin and specify whether the pin should be visible to only the user (“my view”) or to all users (“shared view”). A pin may designate a default view such that, when a user goes to the map view, the view will open to that pin. In the map view, a user may switch between pin locations by either selecting a pin from a list in the window, or by clicking on the pin directly on the map (e.g., using a mouse).

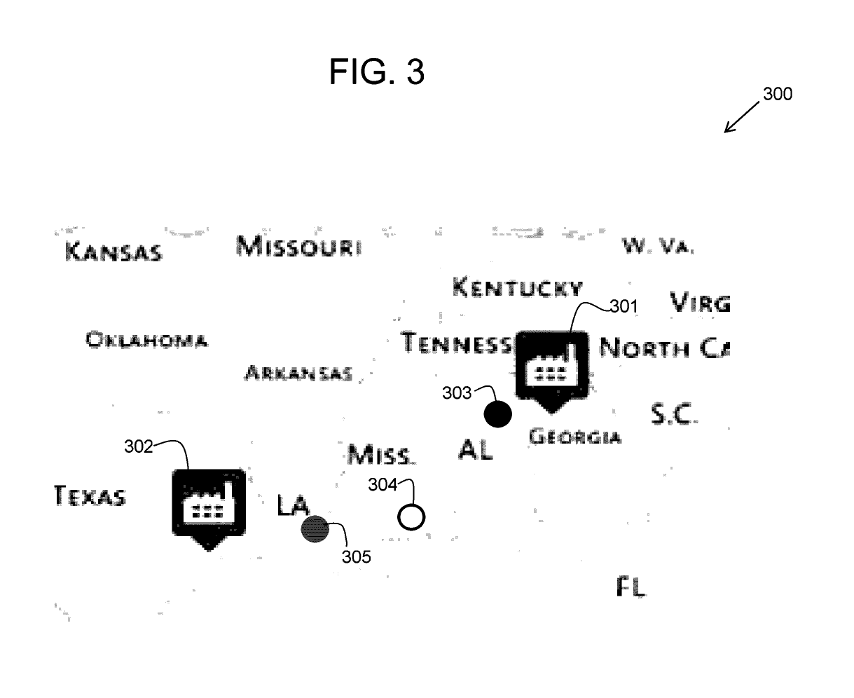

FIG. 3 illustrates an embodiment of a displayed map view 300 of a transportation route provided by the system of FIG. 1. The map view may be a graphic representation of a transportation route between two S/R facilities showing icons of assets carrying product in route between the two S/R facilities. A displayed icon 301 of a shipping facility may indicate on the map view as being located in a first location of the map (in the example of FIG. 3, Georgia). A displayed icon 302 of a receiving facility may be indicated on the map view as being located in a second location of the map (in the example of FIG. 3, Texas). A first group of vehicles and/or containers en route from the shipping facility to the receiving facility may be indicated by the icon 303, which may be located in a third location of the map (in this example, Alabama). A second group of vehicles and/or containers en route from the shipping facility to the receiving facility may be indicated by the icon 304 which may be located in a fourth location of the map (in this example, Mississippi). A third group of vehicles and/or containers en route from the shipping facility to the receiving facility may be indicated by the icon 305, which may be located in a fifth location of the map (in this example, Louisiana). Color coding of the icons, icon shape, and other icon characteristics may be used to indicate various asset characteristics including, for example, product type being transported by the assets and asset container type. A user may place a cursor over an asset icon (e.g., using a computer mouse, touchscreen manipulation, or other user input device) to view additional information (e.g., in text format) about the asset. The additional information may include, for example, weight information about the vehicles and/or containers or product loaded on the vehicles and/or containers, or other way billing information. In one embodiment, there may be an option to toggle to an enhanced mode that addresses disabilities in the user, such as blindness, color blindness, deafness, and the like. Enabling such an option may switch the icons and graphical representations into another mode of presentation—such as to audio, tactile, text, or another mode.

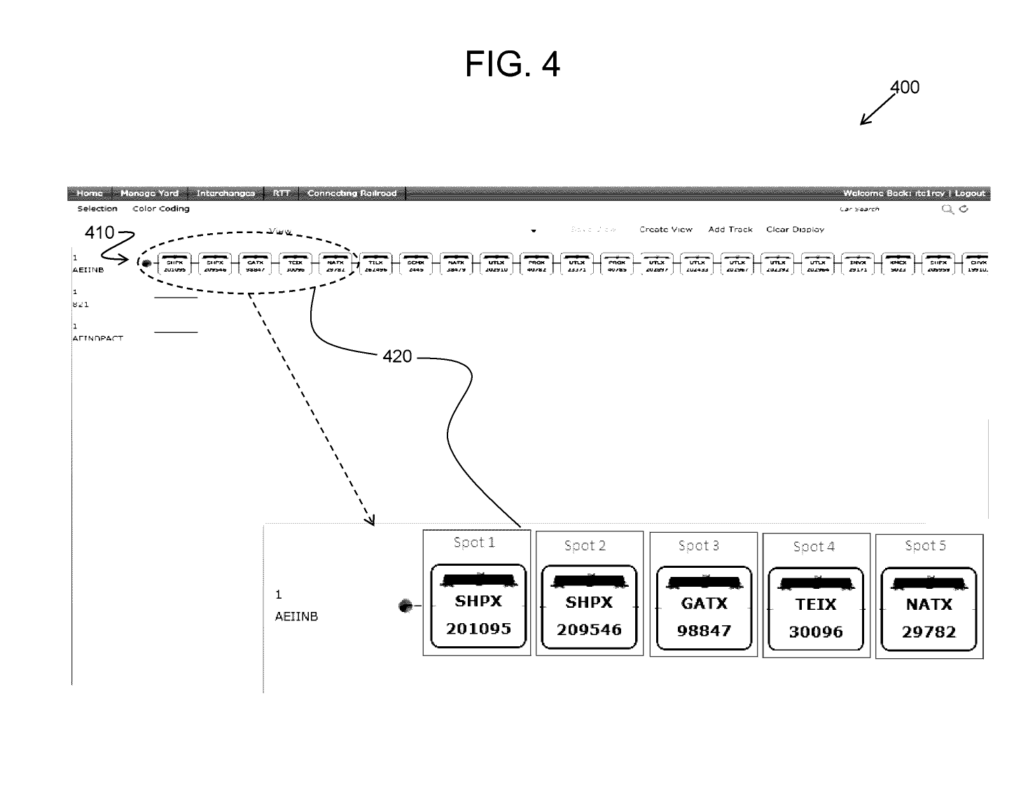

FIG. 4 illustrates an exemplary embodiment of a displayed plant view 400 of the S/R facility provided by the system of FIG. 1. The plant view may be a graphic representation of a string 410 of assets and products on a railway track (e.g., rail cars carrying storage containers on a track) in the S/R facility. The string shows the order of the assets (e.g., rail cars) as they appear on the track in relation to each other in various spots. However, the string does not indicate any particular geographic location(s). A portion 420 of the string 410 may be selectively enlarged for easier viewing in FIG. 4. Views may be created that contain graphical representations of the assets and products that the user works with or that the user works with most often, for example. This allows a user to more easily manage, for example, rail cars between railway tracks and storage areas. The plant view may be organized according to views that contain strings of assets and products specified by the user. A user may group strings together and switch between views by selecting from a “View” drop-down menu.

The system may be configured for a user to edit a view by adding or removing strings and clicking a “Save View” icon. For example, to create a new view, a user may click on a “Clear Display” icon to remove all strings from the window in the plant view. The user may then click the “Add Tracks” icon to select the strings that the user wants to view. The user may select from a list of storage areas that appear, and then click “Done”. All strings associated with the selected storage areas will appear in the view. An individual string or storage area may be removed by right-clicking on the string or storage area name and selecting “Remove from this View”. When a user is satisfied with a view, the user may click the “Create View” icon. A “New View” pop-up window will appear which may be named by the user. Again, the user may specify for the new view to be visible only to the user (My View) or to all users (Shared View).

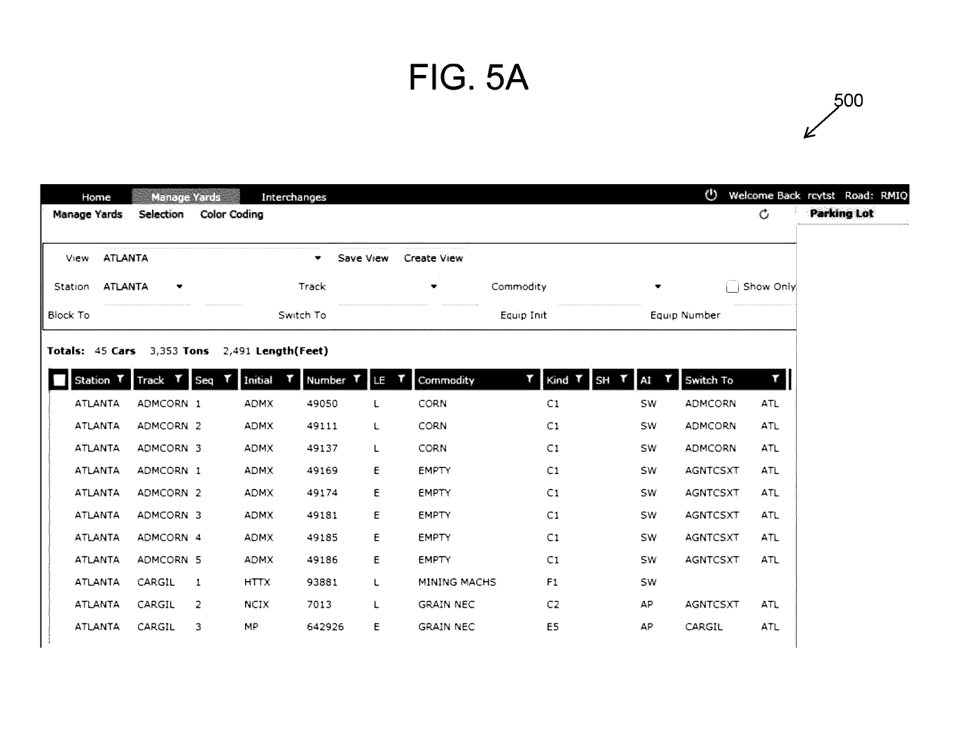

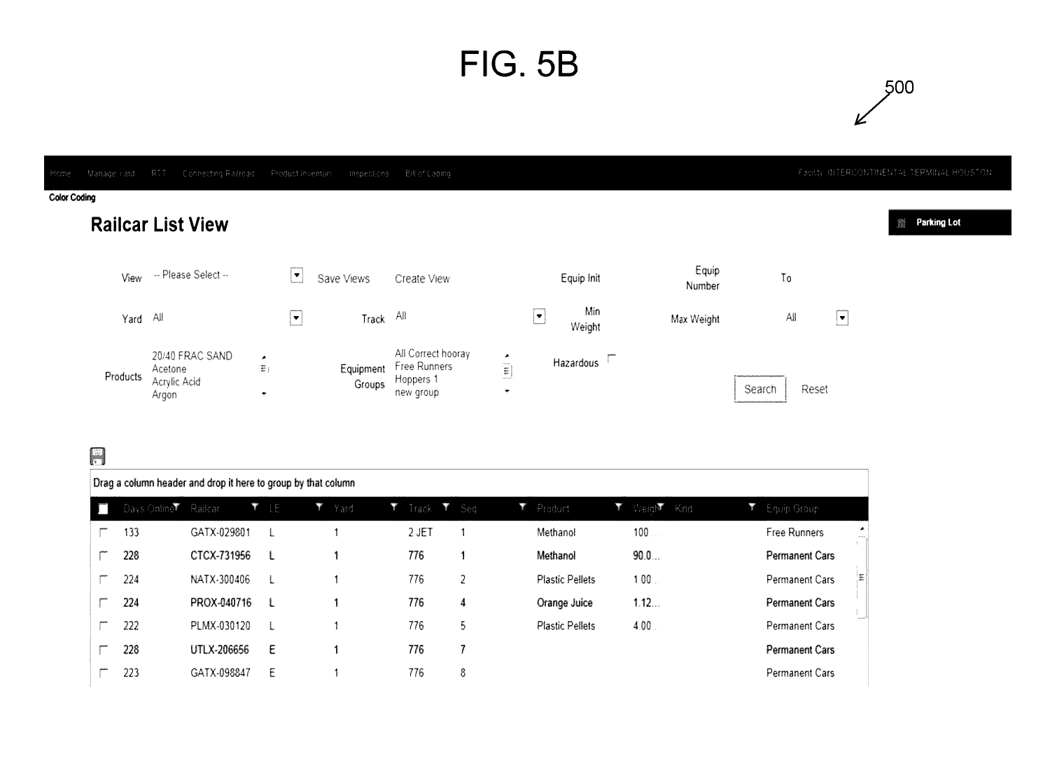

FIGS. 5A and 5B illustrate exemplary embodiments of a displayed list view 500 of the S/R facility provided by the system 100 of FIG. 1. The list view 500 may be a textual representation of assets and products in a plant. For example, shipping vehicles, tracks, and storage areas having product appear in a table format and views may be created that show the storage areas, shipping vehicles, and/or tracks that a user desires. The list view may be organized according to views that contain the assets and products specified by the user and allows a user to view the assets and products the user works with most often, for example. A user may switch between views by selecting from the “View” drop-down menu. A user may create a new list view by selecting “Clear Selection” from the “View” drop-down menu to remove, for example, all tracks and storage areas from the window, select the “Storage Area” and/or “Track” the user wants to view, and click on the “Create View” icon. A “New View” pop-up window will appear and, again, a user may specify a name and visibility of the new view. A user may click the “Update” icon causing, for example, all rail cars associated with a selected storage area and/or track to appear in the view.

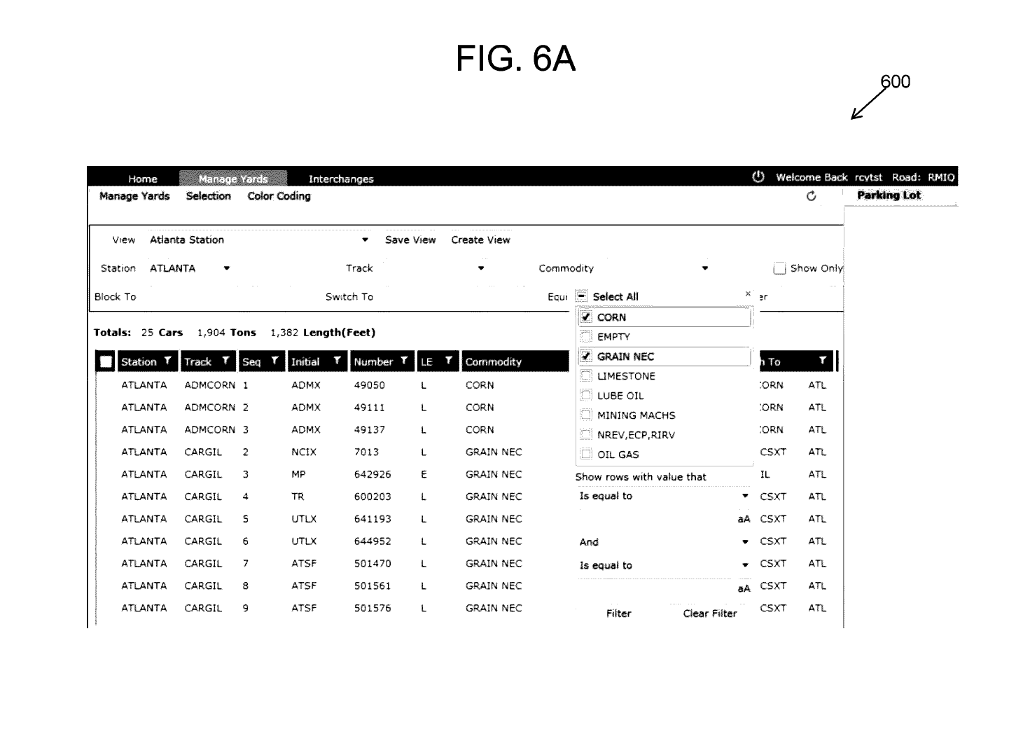

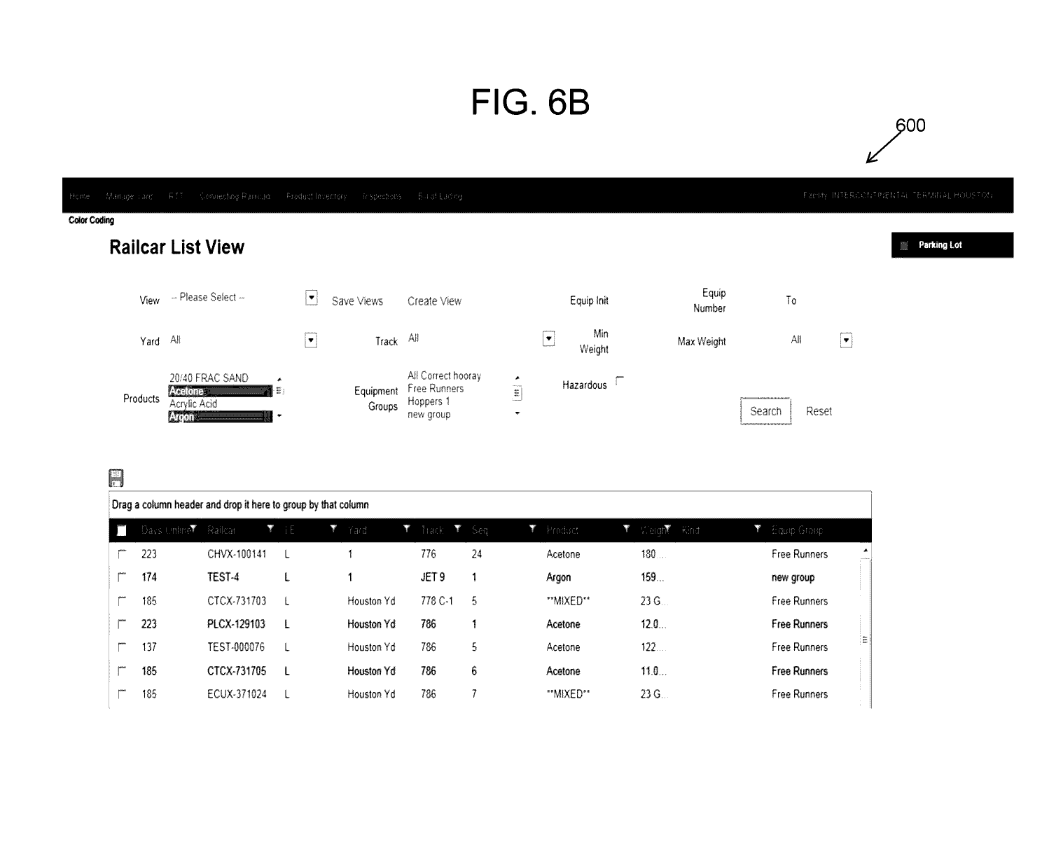

FIGS. 6A and 6B illustrate exemplary embodiments of a data sorting functionality 600 of the system 100, for sorting and filtering the data of the list view(s) of FIGS. 5A and 5B. In accordance with an embodiment, a user may sort the information of the assets and products in the list view by the values in any column. When a user clicks on a column header, the list may be sorted according to the information in that column. If a user clicks the column header again, the sort will change between ascending and descending order.

The system may be configured for a user to also filter the information of the assets and products that appear in the list view using the values in any column. For example, if a user clicks on a filter icon (e.g., displayed with the appearance of a funnel-like element), a pop-up window appears and the user may select from the values appearing in the column or enter the values directly in the free-form fields. In addition to an “equal to” option, the free-form fields also provide a choice of filtering by values that do or do not begin with, end with, or contain a particular value. Once a user makes a selection, only assets and products that match the specified value(s) appear in the list.

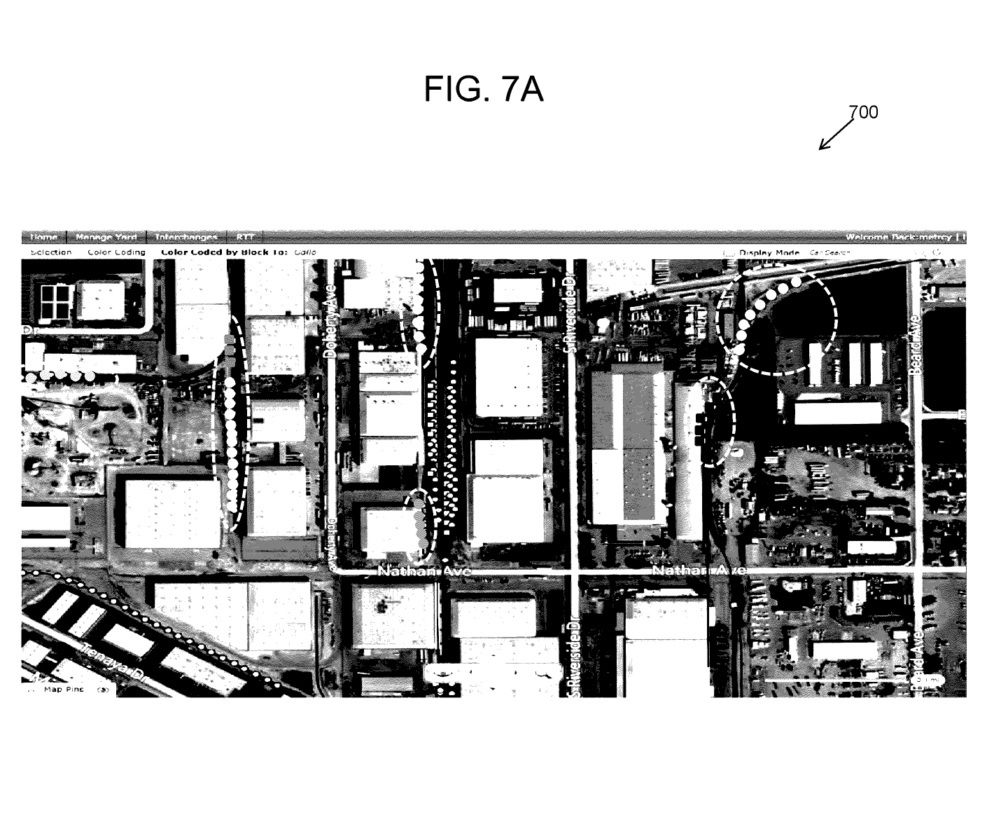

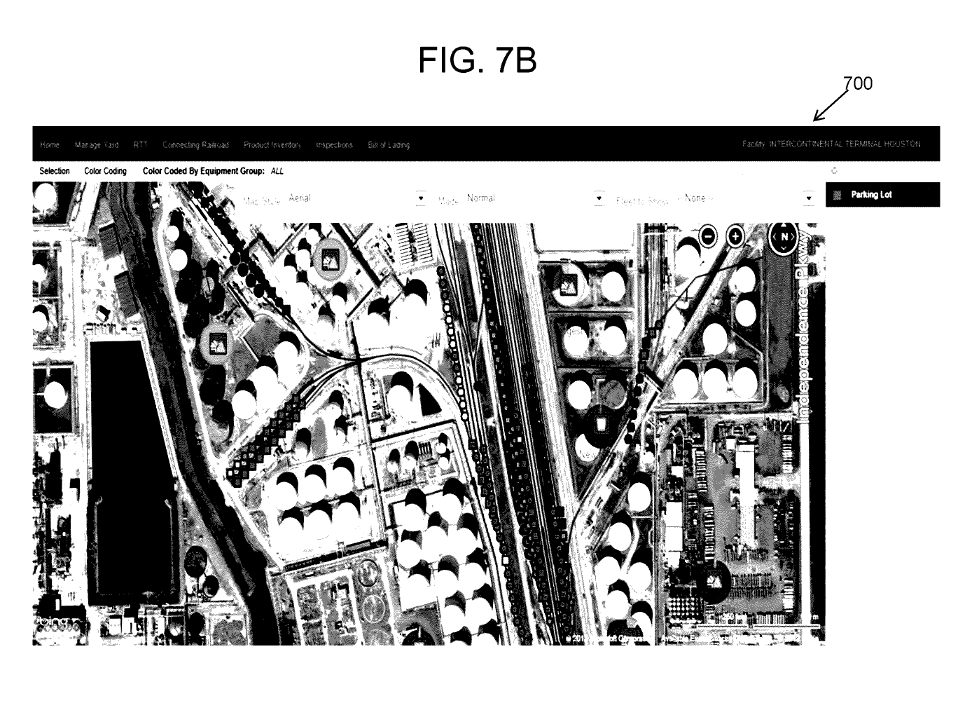

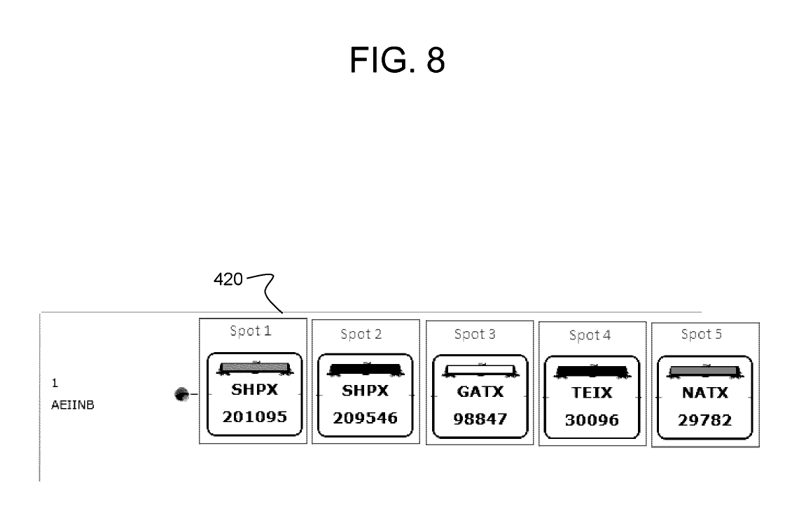

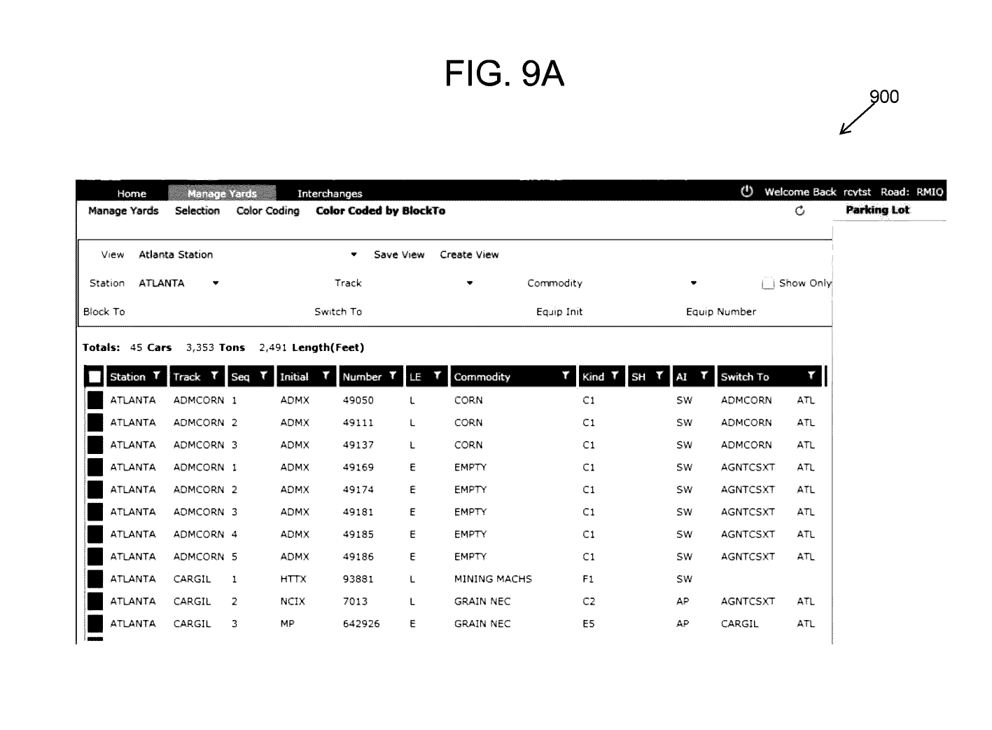

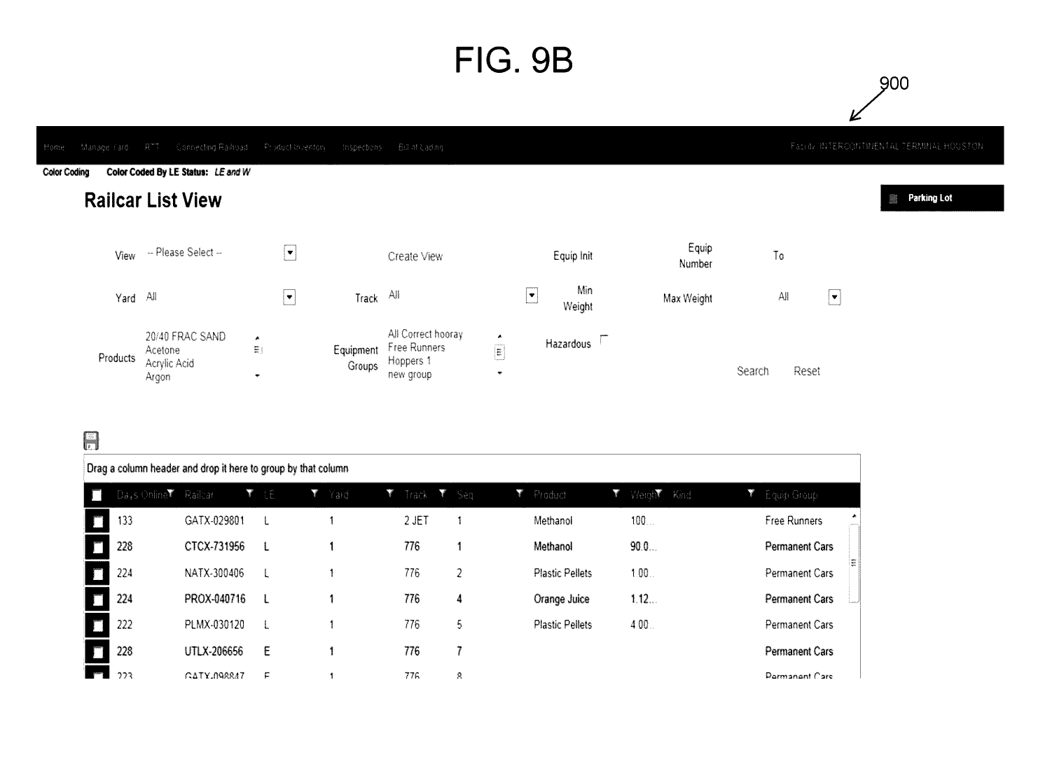

FIGS. 7A and 7B illustrate embodiments of display screens 700 of the system 100 showing the color coding of graphical representations of assets and products in the map view 200 of FIGS. 2A and 2B. Using a “Color Coding” option, a user may highlight, for example, graphical representations of rail cars or transportation vehicles on any view by the following designations: “Equipment Group”, “Car Kind”, “Product”, “Hazardous, or “Status”. As a result, a user may find particular groups of cars quickly by selecting a designation from a “Color Coding” drop-down menu, causing the corresponding cars to appear highlighted in the view. The color-coded assets may be shown in the areas within the dashed white ovals in FIGS. 7A and 7B. Similarly, FIG. 8 illustrates an exemplary embodiment of a portion 420 of the string 410 of the displayed view 400 of FIG. 4, showing the color coding of the assets and products of the portion 420. FIGS. 9A and 9B illustrate an embodiment of a displayed view 900 showing the color coding of assets and products in the list view 500 of FIGS. 5A and 5B. FIGS. 3 and 7-9 herein illustrate the color coding in terms of shades of gray. However, in accordance with an embodiment, the color coding may be accomplished with other non-gray scale colors, providing better discernment to the user. Other types of asset and product coding may be possible as well such as, for example, shape coding of asset and product icons, intensity coding of asset and product icons, and flashing coding (e.g., a displayed icon is first displayed and then not displayed in a regular repeating pattern) of asset and product icons.

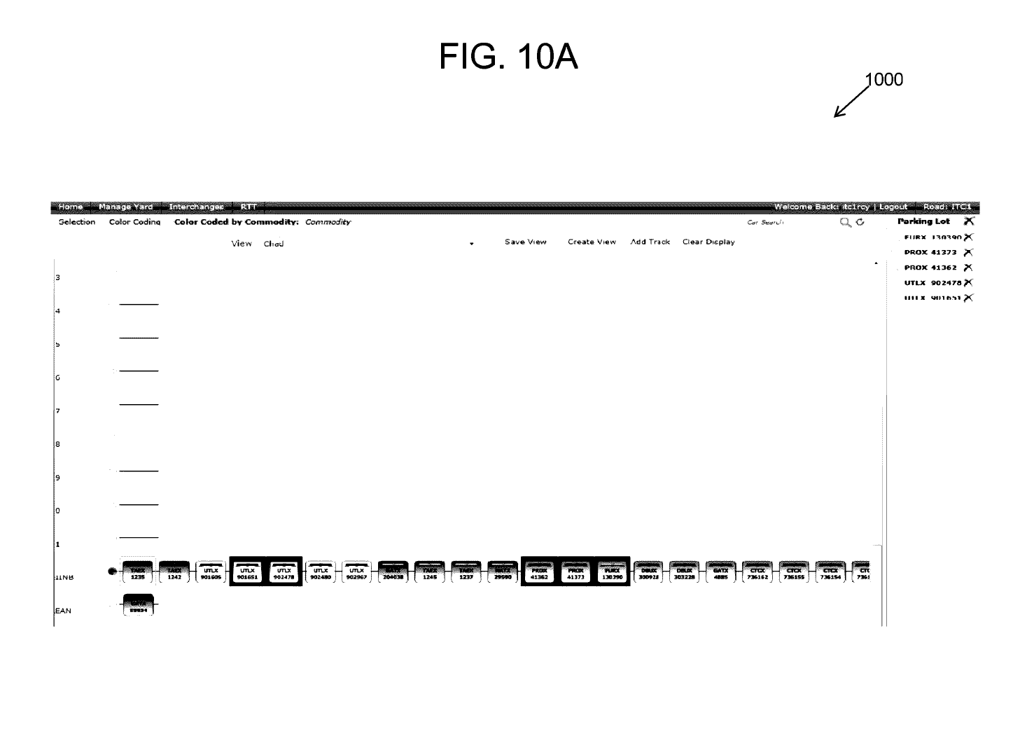

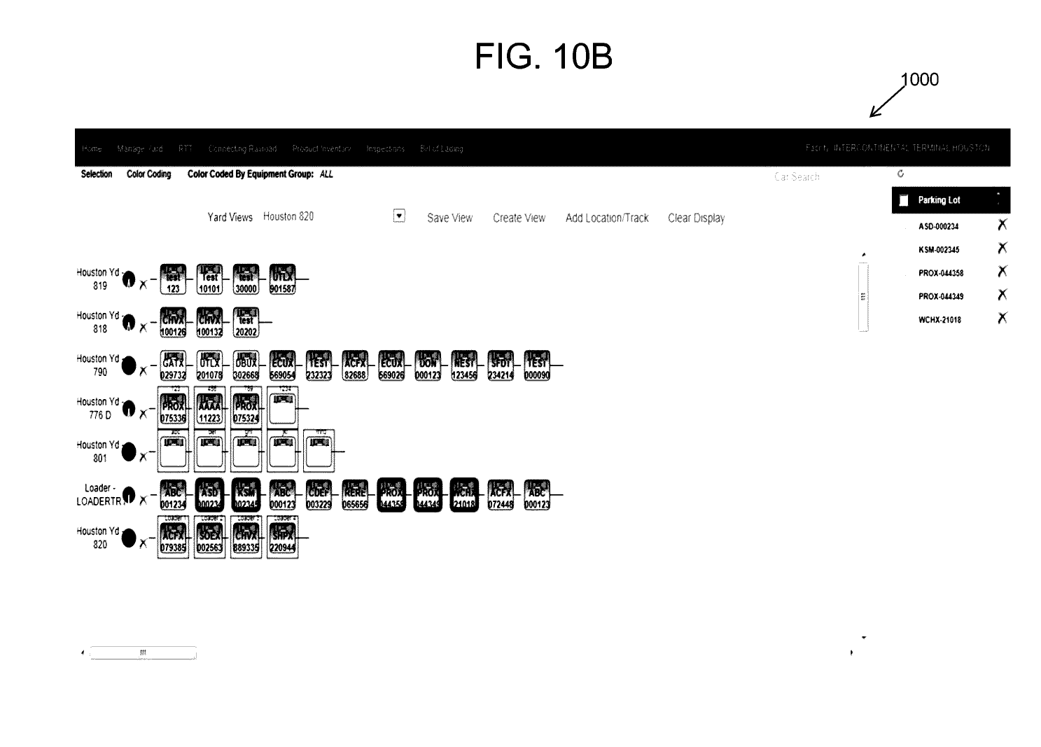

In accordance with an embodiment, the system may be configured for a user to select shipping vehicles in any view based on a variety of criteria including vehicle ID, location, Equipment Group, or Product, allowing a user to choose groups of vehicles quickly and take action based on the criteria. A “parking lot” area or holding area may be provided in each view. For example, FIGS. 10A and 10B show embodiments of display screens of the system 100, which include a parking lot function. The parking lot function allows a user to temporarily place a group of graphical representations of vehicles and/or containers, with which the user wants to work, into a designated portion of the display (the “parking lot” area) where they may wait until the user is ready to act upon them. To place a graphical representation of a vehicle, or multiple vehicles (e.g., a string), in the parking lot area, a user may select the vehicle(s) and drag and drop the vehicle(s) to the parking lot area in the window. Moving a vehicle to the parking lot area does not make any changes to the vehicle in the system. However, once a group of vehicles are placed in the parking lot area, a user may readily select the entire group and edit the corresponding Bill of Lading information, or move the group of vehicles together within the representation of the S/R facility within the system 100. The user may then work with several vehicles that may be currently on different tracks or paths, or when the user wants to add multiple vehicles to a consist, for example.

In accordance with an embodiment, the system 100 may be configured for a user to select a “Display Mode” check box to make the parking lot area disappear from the displayed window in the map view. This provides the user with more room to work in the view. Furthermore, when in the “Display Mode”, the system may update automatically or be manually refreshed to provide the up-to-date information to the user. The user may draw and edit tracks and storage areas such that the map view will match the setup of the plant operation.

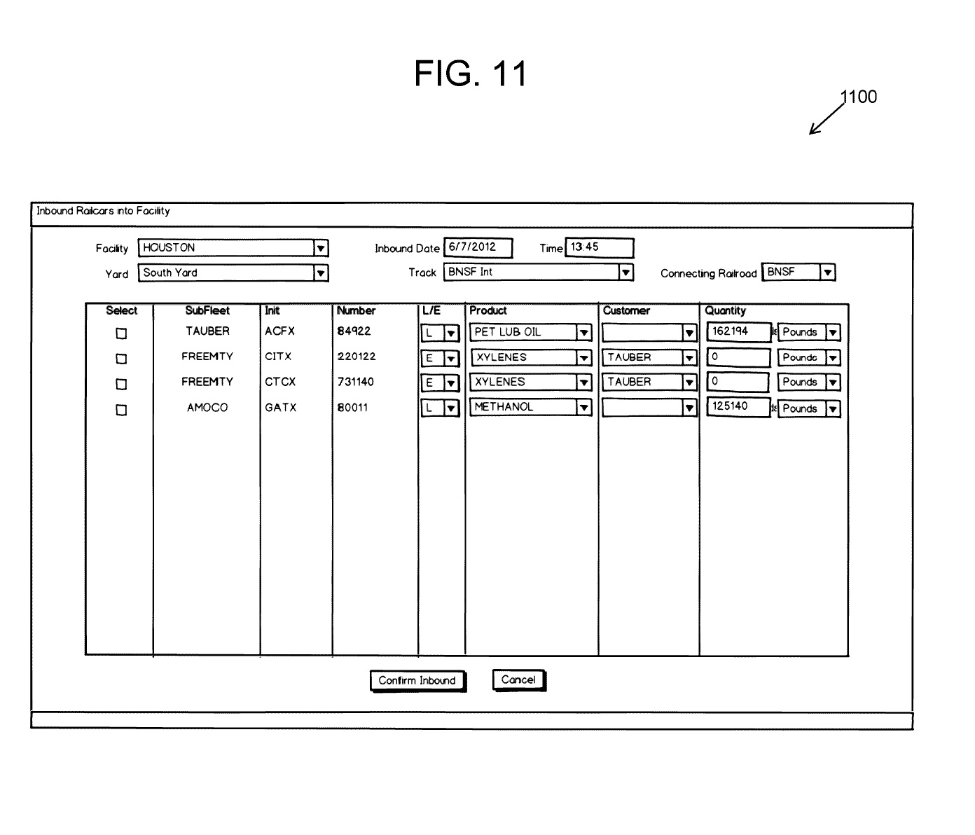

FIG. 11 illustrates an exemplary embodiment of a display screen 1100 generated by the system of FIG. 1 showing information associated with providing interchange support of assets (e.g., inbound rail cars) into the S/R facility. For example, the displayed information may include header information of facility, yard, date and time, track (or road or other asset route), connecting railroad or other connecting shipper, and so on, plus a selectable list of incoming assets (e.g., rail cars) that includes displayed information of subfleet, asset identifier (“Number”), information of what the assets are carrying, and quantities of what the assets are carrying. As part of the user interface, the display screen may include options for a user to modify the information of the incoming assets, confirm the incoming assets, or cancellation of any modifying actions.

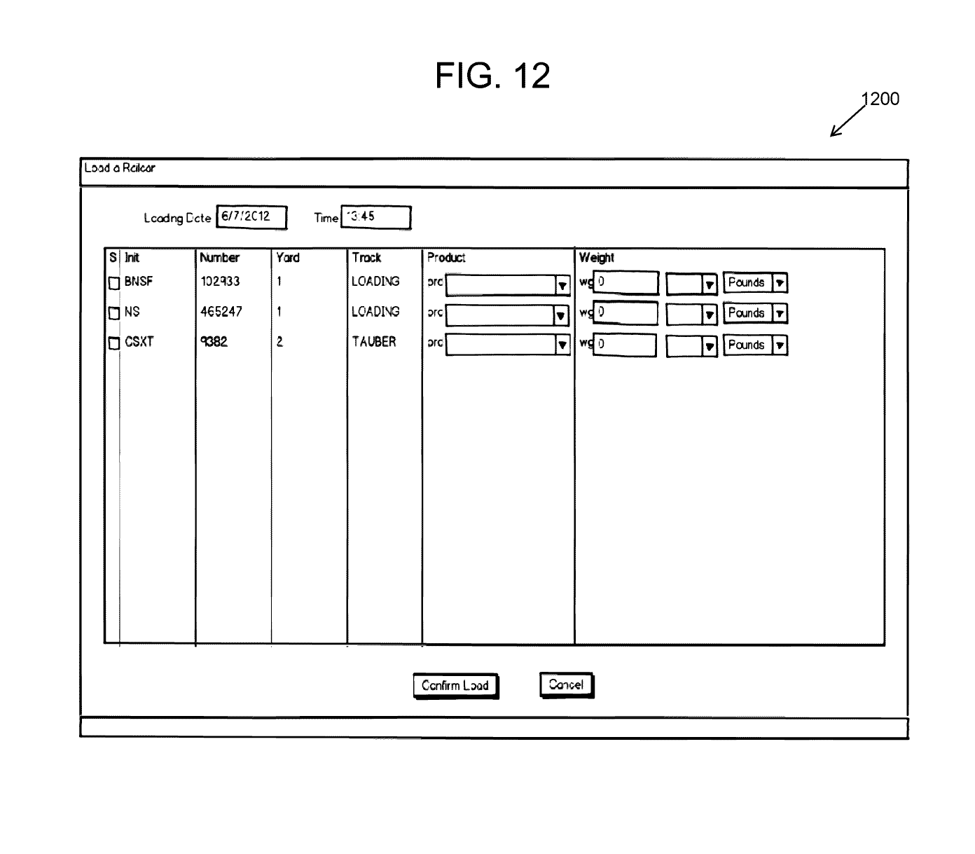

FIG. 12 illustrates an exemplary embodiment of a display screen 1200 generated by the system of FIG. 1 showing information associated with loading an asset (e.g., a railcar) within the S/R facility. For example, the display screen may include a loading date and time in the header, and a list of assets that are to be loaded, or that are being loaded, at or around that time/date. Displayed information of the assets may include asset number or other asset identifier, owner or shipper information, track or other route information of where the asset is currently, or where the asset is to be loaded, and modifiable information of products (e.g., type of product and weight or mass of product) being loaded (or to be loaded) onto the assets.

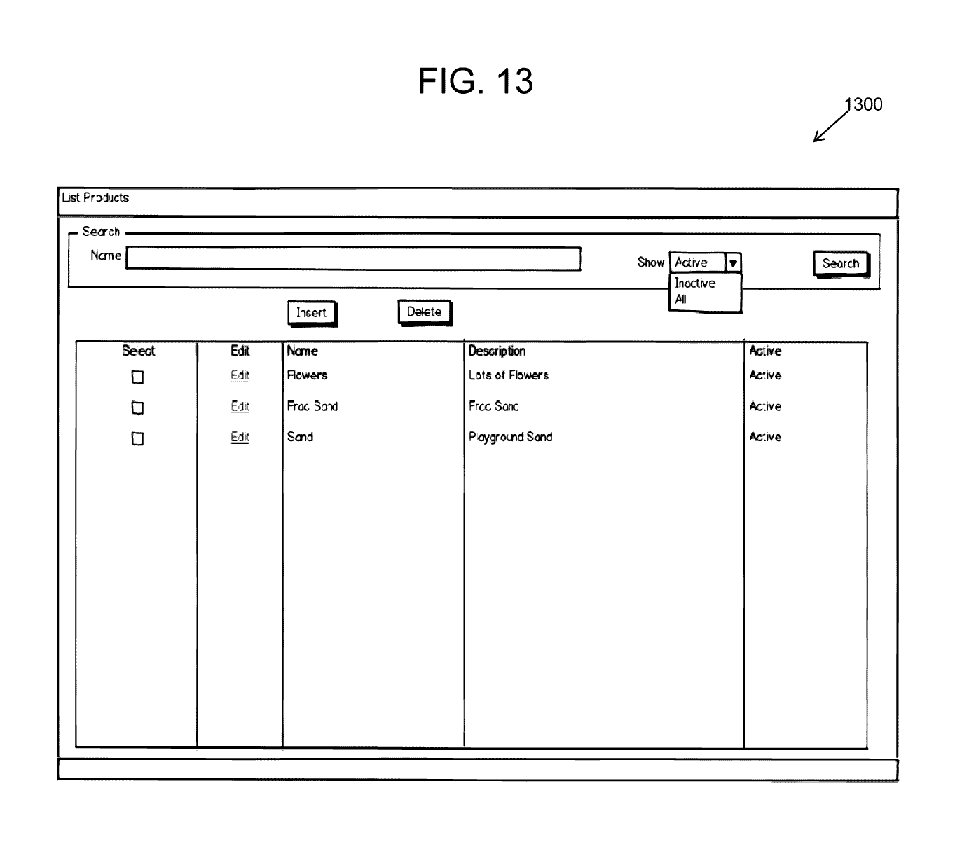

FIG. 13 illustrates an exemplary embodiment of a display screen 1300 generated by the system of FIG. 1 showing information associated with a product master list. For example, the product master list may be a displayed list of product information stored in a database (and associable with assets in others of the displayed screens—see FIGS. 11 and 12 for example), which can be modified via insertion of new products, deletion of existing products, and selection and modification of individual ones of the products, in terms of information about the product such as product name, product description, and whether the product is designated as inactive or active in the system (active meaning currently associable with assets, and inactive meaning not currently associable with assets).

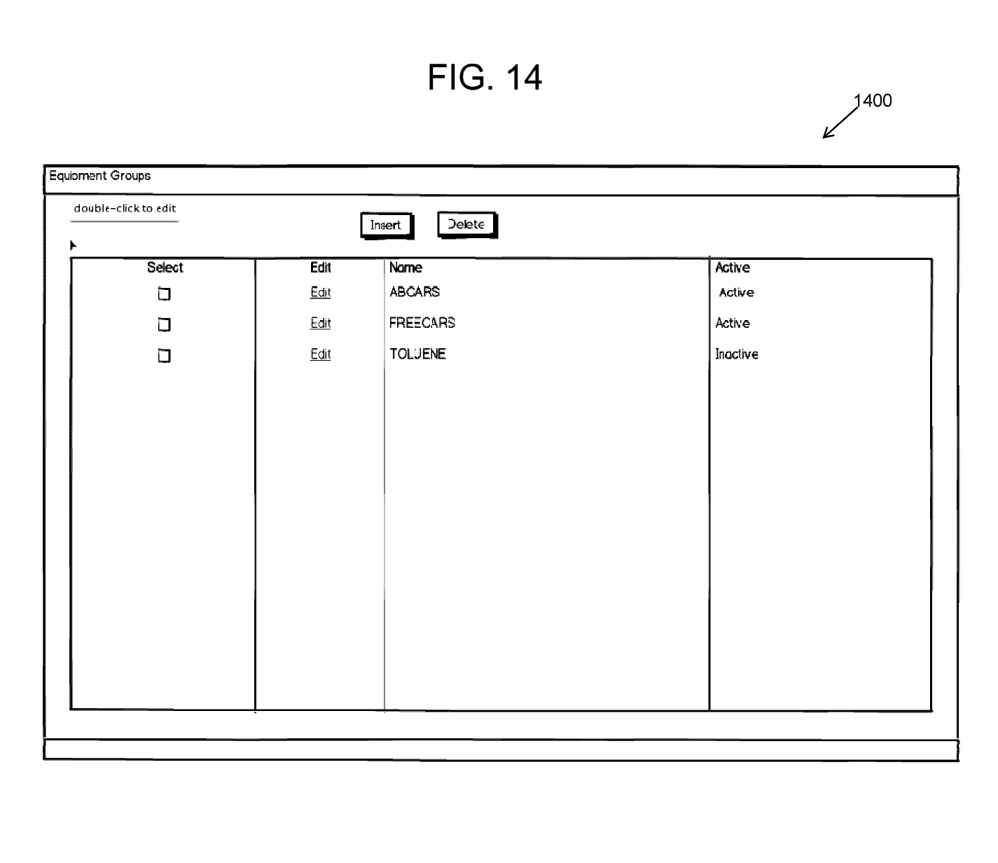

FIG. 14 illustrates an exemplary embodiment of a display screen 1400 generated by the system of FIG. 1 showing information associated with an equipment group master list. For example, the equipment group master list may be a displayed list of equipment group information stored in a database (and associable with assets in others of the displayed screens), which can be modified via insertion of new equipment groups, deletion of existing equipment groups, and selection and modification of individual ones of the equipment groups, in terms of information about the equipment groups such as equipment group name and whether the equipment group is designated as inactive or active in the system.

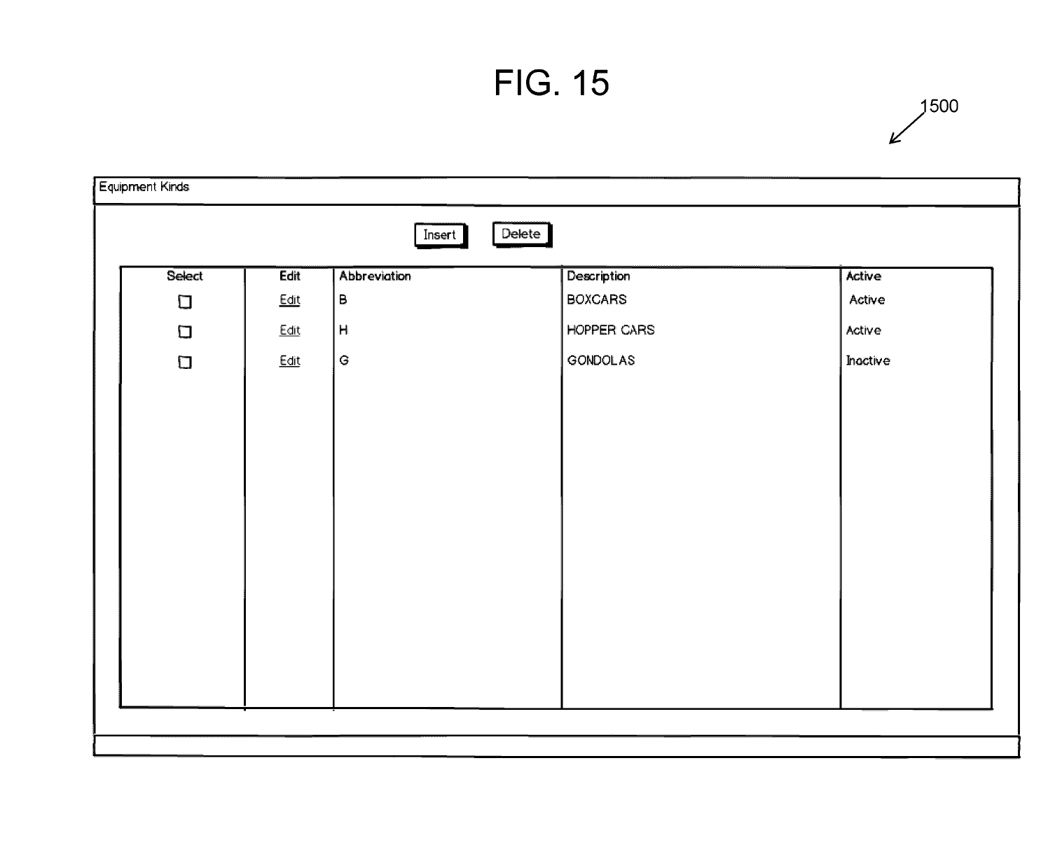

FIG. 15 illustrates an exemplary embodiment of a display screen 1500 generated by the system of FIG. 1 showing information associated with an equipment kind master list. For example, the equipment kind master list may be a displayed list of equipment kind information stored in a database (and associable with assets and/or equipment groups in others of the displayed screens), which can be modified via insertion of new equipment kinds, deletion of existing equipment kinds, and selection and modification of individual ones of the equipment kinds, in terms of information about the equipment kinds such as equipment kind abbreviation, equipment kind description, and whether the equipment kind is designated as inactive or active in the system.

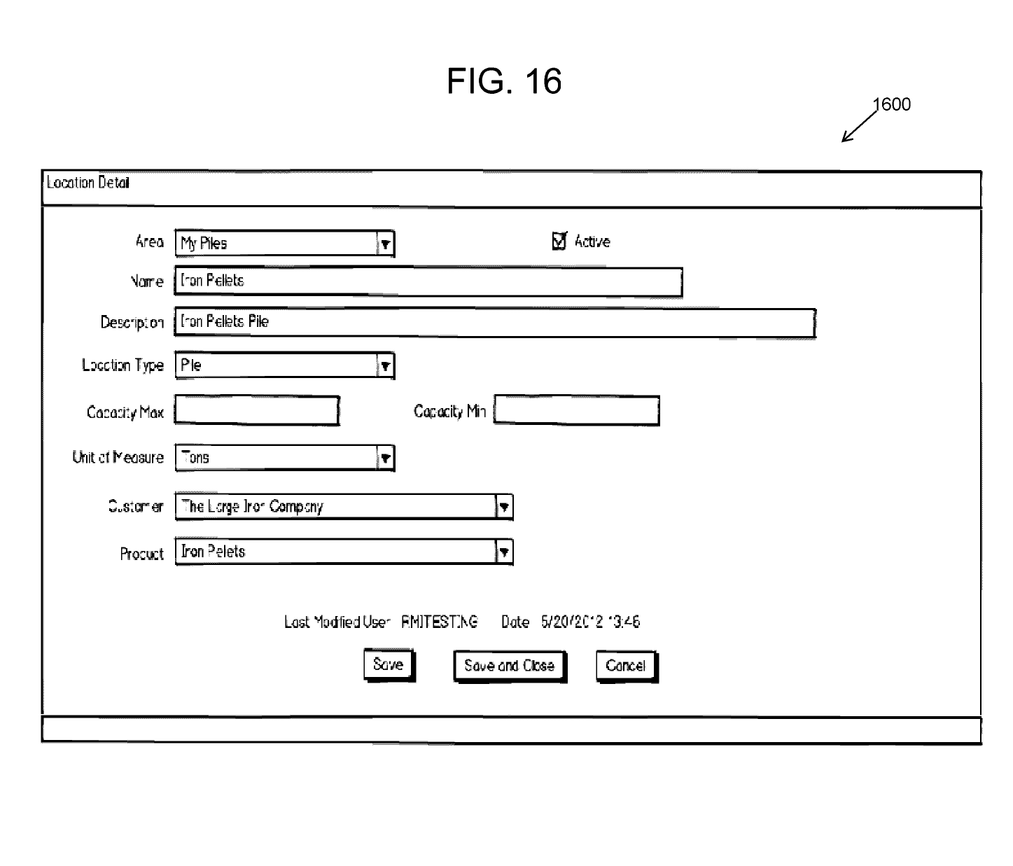

FIG. 16 illustrates an exemplary embodiment of a display screen 1600 generated by the system of FIG. 1 showing information associated with a location (e.g., storage area) master list. For example, the location master list may include, as part of the displayed user interface, user-editable fields for access and modification of associated data records stored in the system. The fields (and associated data record entries) may include location area, location name, location description, location type, location capacity (minimum and/or maximum capacity of what is stored at the location), designated unit of measure of the capacity, customer, and product.

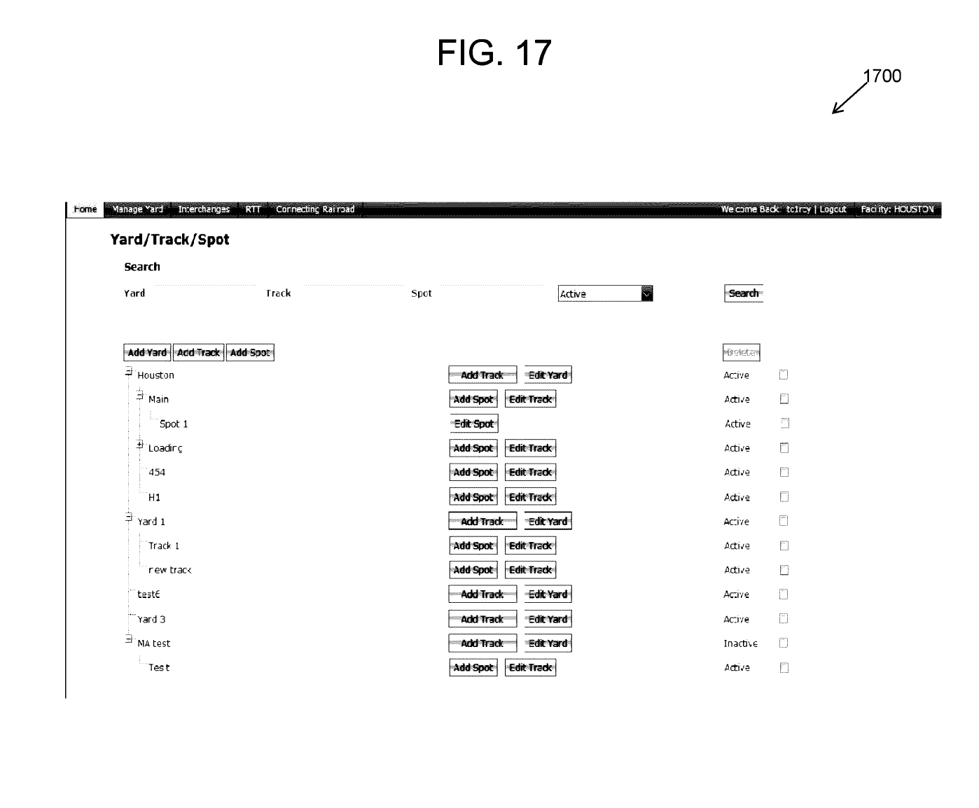

FIG. 17 illustrates an exemplary embodiment of a display screen 1700 generated by the system of FIG. 1 for the setup of infrastructure (e.g., a plant, a track, and/or a spot) within the S/R facility. For example, the display screen may include, as part of the displayed user interface, search fields for user entry of infrastructure information to search for in the system (e.g., search by yard, track, or spot), a display of existing infrastructure (e.g., displayed as a nested hierarchy of infrastructure), user-selectable icons for adding or editing infrastructure elements, and user-selectable icons (e.g., check boxes or radio buttons) for activating and inactivating the infrastructure elements.

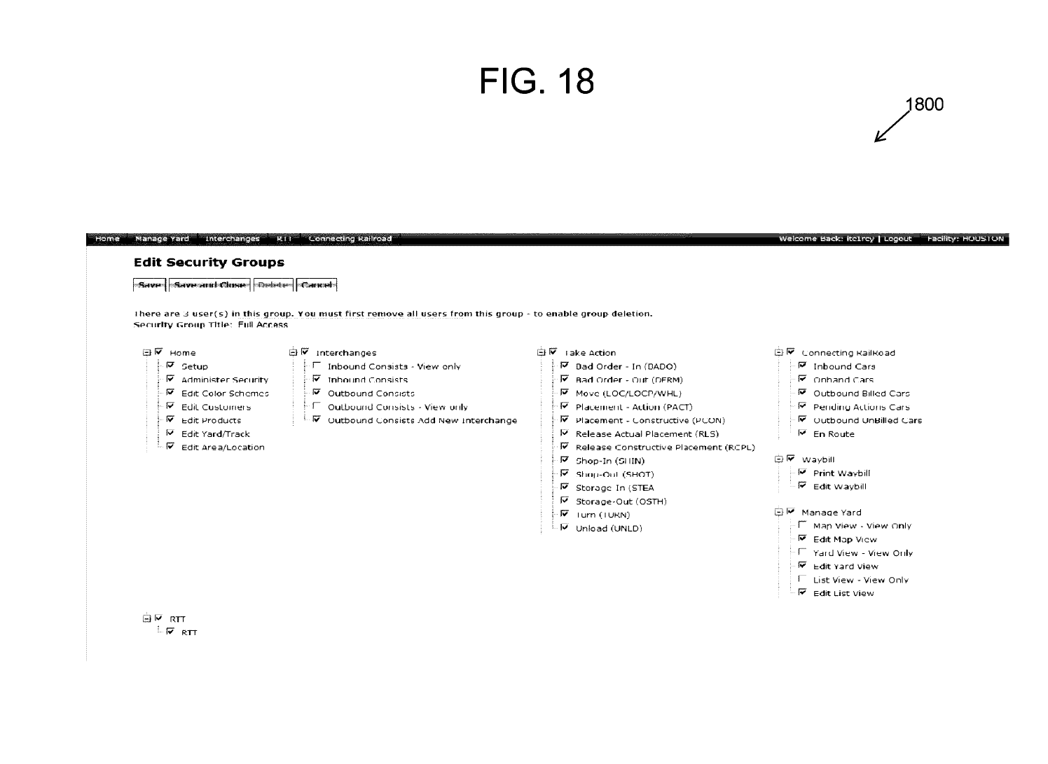

FIG. 18 illustrates an exemplary embodiment of a display screen 1800 generated by the system of FIG. 1 for security and user setup. For example, the display screen may include, as part of the displayed user interface, user-selectable options for allowing respective users in one or more designated groups of users to access (or not access) the various functions of the system.

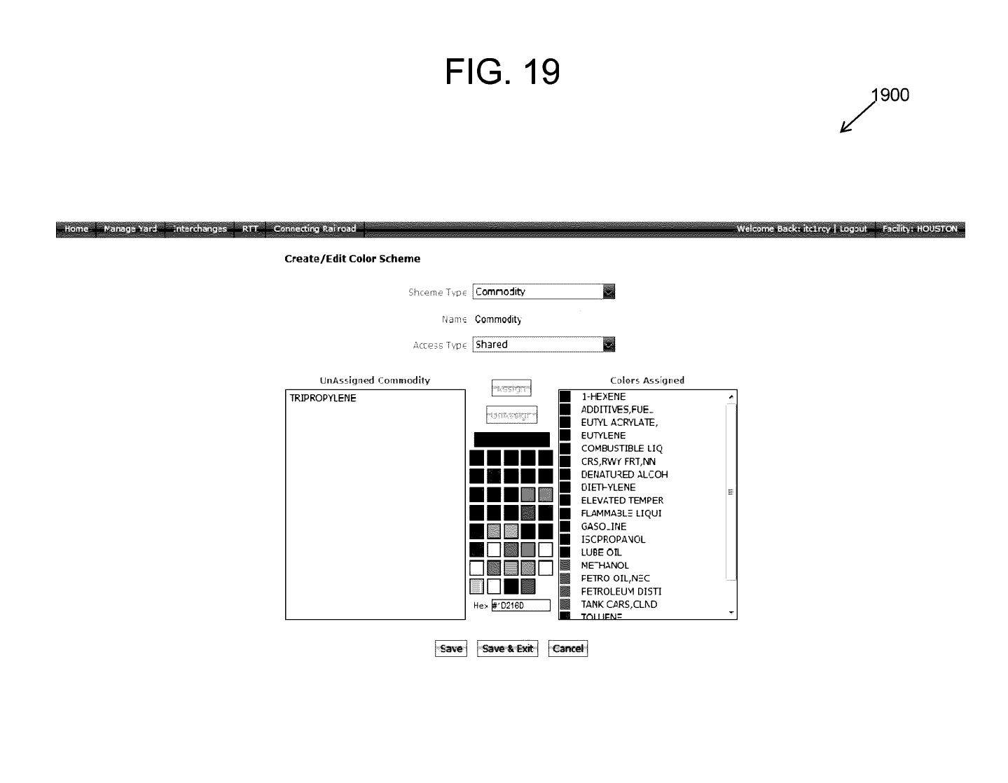

FIG. 19 illustrates an exemplary embodiment of a display screen 1900 generated by the system of FIG. 1 for a color scheme setup of the system. For example, the display screen may include, as part of the displayed user interface, one or more user selectable and/or editable fields for selecting a color scheme type (e.g., each color scheme type may be associated with a particular group of assets, type of product carried on assets, or the like, and for assigning various colors to members of the color scheme type. For example, for each product in the system, the system may be configured for a user to assign a color that is uniquely associated with that product in the system.

In accordance with an embodiment, the controller and the user device may be operable to facilitate the modification of a graphical representation of the S/R facility displayed on a display screen of the user device, facilitate the modification of characteristics of graphical representations of products and assets located within the S/R facility which may be displayed on the display screen of the user device, and facilitate the movement of graphical representations of products and assets within the S/R facility on the display screen of the user device as commanded by the user, including the loading and unloading of products onto and off of assets. The graphical representations and movements may correspond to actual facilities, products, assets, and the actual characteristics and movements of those products and assets in the real world. The modification of a graphical representation of the S/R facility may include adding or deleting graphical representations of tracks or storage areas within the facility. The modification of graphical representations of products and assets may include color coding the displayed products and assets. The modification of graphical representations of products and assets may include assigning characteristics to the products and assets.

Although trains of rail cars are referred to herein in reference to certain embodiments, certain other embodiments may apply to vehicle consists more generally. A vehicle consist is a group of vehicles that are mechanically linked together to travel along a route. A rail vehicle consist is one example of a vehicle consist, and a train. (e.g., having one or more locomotives for propulsion and one or more rail cars for carrying products and/or passengers and not configured for propulsion) is one example of a rail vehicle consist. Another example of a rail vehicle consist is a set of mining ore carts. A powered vehicle consist refers to the interaction of two or more powered vehicles that may be mechanically, informationally, or otherwise linked together, as may be the case for a locomotive consist (having multiple locomotives to move a train including the locomotives and one or more unpowered rail cars or other unpowered vehicles).

In one embodiment, the system may record asset and product movement events within the S/R facility. When an actual asset or product moves in an actual S/R facility, a user of the system may update the system to reflect the move. This may be done, for example, by dragging and dropping the icon corresponding to the asset or product in a view displayed on the user device. Assets and products may come into the S/R facility through an inbound interchange process. In embodiments, the system is configured so that a user cannot move, place, release, load, or unload assets or products in the system until they are interchanged to the S/R facility. Assets and products stay within the S/R facility until a user moves them to a serving carrier through an outbound interchange.

Using the system, simple track-to-track moves may be made within facility limits. Also, “Classifying” a track provides a way to rapidly move cars and create history records in a large facility, for example. Furthermore, “Fanning” a track allows a user to move cars from one track to multiple other tracks within a facility. Also, “Resequencing” allows a user to change the order of cars on a track. In accordance with an embodiment, the “Classifying”, “Fanning”, and “Resquencing” functions are implemented as scripts or macros in the system. Other scripts or macros can be used to automate or aggregate a series of steps that are repeated and therefore to collapse longer routines into a single action (or the equivalent).

In the system, Several move types related to storage are defined that allow a user to move an asset or product into and out of storage, may be recorded to movement history, and may be used to generate storage billing. Several move types may be provided for recording when an asset or product may be defective and in need of repair or replenishing. For example, vehicles and/or containers may be marked as “bad order” in the system and may be flagged on various windows and reports throughout the system. When the car is repaired, the car may be moved in the system off the “bad order” list. Each time a car is moved by a user in the system, a record of the move may be written to a car movement history file which may be accessed.

The controller and associated management software application 115 may include logic that provides an assessment, in comparison to one or more designated criteria, of the movement of assets and products in the system as initiated by a user. For example, there may be some asset movements that may be impossible, highly improbable, or unlikely to take place in a facility. If a user attempts to make such a movement of an asset in the system, the system may disallow the move or at least provide an indication to the user that the move may be highly unusual and suggest that the user may want to reconsider the move. Furthermore, movement of assets and products within the system made by a user may be verified, for example, against data collected within the actual facility corresponding to the actual movement of the assets or products, e.g., RFID data or optical character recognition (OCR) data. The actual movement of assets and products in the facility may also be time stamped, allowing the system to perform efficiency analysis of the movement of assets and products through the S/R facility.

In accordance with an embodiment, the system allows a user to review and edit shipping and receiving information for any asset and associated product. For example, basic shipping/receiving information (e.g., Bill of Lading or waybill information) for a car or other asset may appear on the screen when a user, for example, hovers a cursor over that car on the display screen. The S/R information may be edited by right-clicking on the car and selecting “Edit S/R Information”, for example. Data may then be edited and/or added via a pop-up window. In accordance with an embodiment, data fields include “Customer”, “Equipment Group”, “Product”, “Quantity” and “Seals”. Other S/R data fields (e.g., load railcars, unload railcars, associate with an order, outbound railcars, and inspections) may be possible as well, in accordance with various embodiments of the invention.

In accordance with an embodiment, the system allows a user to periodically review consists delivered to the S/R facility. When the user sees a new inbound consist listed, the user may check the cars on that consist and plan for interchanging and switching cars as they may be received. Cars of an inbound consist may be officially accepted by the user and moved into inventory in the S/R facility. Cars cannot be moved in the system until the user interchanges them online, however. After cars may be accepted from a consist, the cars may be managed automatically or manually via the system. When a user is ready to deliver cars from the S/R facility, a user may transmit the outbound consists in advance of actual delivery, or transmit the outbound consists at the time of delivery. Once an outbound interchange is delivered, the cars may be tracked and managed along the route to the destination facility.

In one embodiment, the user device has functionality to determine its own location, the current time, and to identify a nearby asset or product via, for example, near field RFID, barcode scanning, manual entry, OCR, or the like. This allows a user to update the system with an asset or product location at a particular time. The system may then compare the gathered information against an assumed location of the asset or product. Alternatively, using the location of the user device and the assumed location of the asset or product, the system may guide a user to the asset or product.

The system may indicate certain paths, track sections, or storage areas that may be occupied, or will be occupied, or may be closed (e.g., for repair). The system may then calculate an optimal path from the current location to a user indicated new location. That path may be checked against the path or track sections that may be unavailable, or may be unavailable during the time such a move of the asset or product may be intended. In one aspect, the path of travel may be indicated on the user device, and the path may be re-drawn by user input and/or by other rules or constraints applied by the user.

In one embodiment, a future arrival of a vehicle or container may be indicated as well as an estimated time of arrival of that vehicle or container. Thus, the S/R facility may indicate an inbound train, calculate a breakdown of the incoming containers, and check for existing obstructions on the intended path of the incoming containers so that such obstructions (such as other parked assets) may be moved prior to the arrival of the vehicle or container.

In particular embodiments, aspects can be directed toward optimization of at least assets at one or more facilities. In at least one embodiment, a method that can facilitate at least asset optimization is provided. The method can include various aspects using a controller, such as receiving a shipping schedule including a set of scheduled orders, receiving a new order identifying at least one product to be shipped, identifying one or more assets available to the new order, calculating at least one cost associated with the new order and the one or more assets available, selecting at least one of the one or more assets available to complete the new order based on the shipping schedule and the at least one cost, and adding the new order to the shipping schedule. The method can further comprise modifying a scheduled order among the set of scheduled orders based on the new order, and/or removing an associated asset from selection for the scheduled order to accommodate the new order. The at least one of the one or more assets can contain one or more portions of the at least one product associated with the new order and the scheduled order. In embodiments, the one or more assets available can employ two or more modes of transportation (the two or more modes of transportation including ground rail, ground non-rail, air, water, and so forth). In additional aspects, the one or more assets available can be operated by two or more entities, at least one of the two or more entities being a private fleet. In particular embodiments, the new order to the shipping schedule can include scheduling two or more separate shipments to complete the new order. In further aspects, the method can additionally include changing a route of the scheduled order to accommodate the new order, and/or reserving a private asset selected for the new order from the private fleet, the private asset is selected for the new order. The method can additionally include identifying location information related to the new order, the set of scheduled orders, the at least one product, and the one or more assets available, as well as rendering a display of at least a map including a graphical representation of the location information. The method can in addition include at least calculating an expected availability period associated with a non-available asset based on the shipping schedule, using the controller. In at least one embodiment, a controller can be provided. The controller can be configured to process a shipping schedule including a set of orders, process an equipment availability matrix including a set of assets based on the shipping schedule, determine one or more costs based on at least the set of orders and the set of assets, identify one or more possible shipping solutions associating one or more assets from the set of assets with at least one order from the set of orders to fulfill the set of orders in accordance with the shipping schedule, and select a preferred shipping solution based at least on the one or more costs. The controller further can be configured to identify a group including two or more assets among the set of assets based at least in part on an asset type, an asset location, and an asset utilization, and/or calculate one or more group costs attributable to the group based at least on a group per-mile cost or a group per-day cost. In additional aspects, the controller can further be configured to select one or more routes associated with the preferred shipping solution based on at least a route discount. In at least one embodiment, a system can be provided that includes at least an enterprise resource planning system configured to manage a plurality orders and a plurality of assets during a period of time. The system can also include a controller communicatively linked to the enterprise resource planning system, and a user device communicatively linked to the controller and configured to receive the shipping plan. The controller can be configured to analyze a plurality of order-asset combinations to determine a plurality of order-asset costs and order-asset revenues, and can schedule the plurality of orders using at least a portion of the plurality assets to a shipping plan based on the order-asset costs and order-asset revenues. The enterprise resource planning system can further be configured to update an asset availability matrix based on the shipping plan. In alternative or complementary embodiments, the enterprise resource planning system can further be configured to project an availability period of at least one asset among the plurality of assets based on a transit time of the shipping plan, a customer dwell time, a repositioning time, and a maintenance time. In addition, the shipping plan can be further based on a target daily asset loading and a maximum daily asset loading, and/or the user device is further configured to modify the shipping plan based on a customer input in various embodiments.

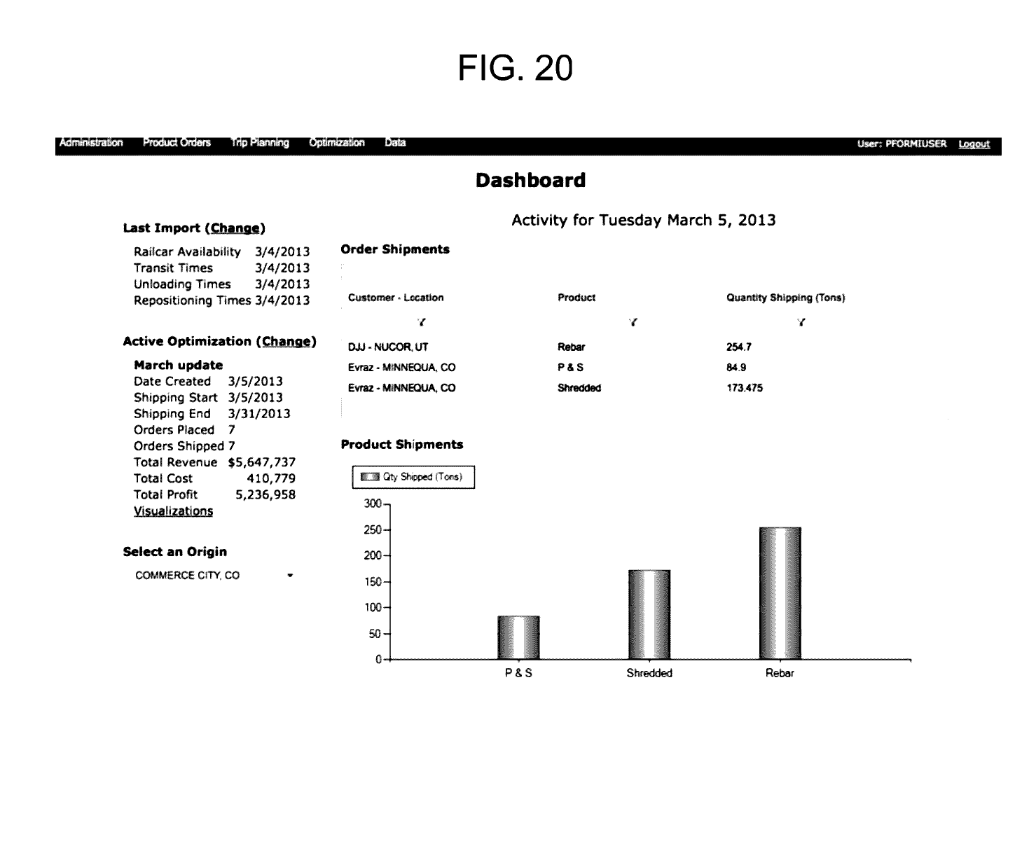

FIGS. 20-35 illustrate exemplary embodiments of display screens of an example interface related to fleet management modules and aspects as described herein. Various aspects therein can be utilized with systems and methods described herein in accordance with at least the following aspects directed toward various dashboards or interface.

In embodiments directed toward rail fleets, a rail fleet optimization solution suite can build shipment plans to optimize rail fleet productivity according to variables. Decision variables to be managed can include a number of possible shipments, shipment revenue amounts, shipment revenue targets or constraints, calculation or application of freight rates, tracking or estimation of transit time, tracking or projection of expenses associated with the use of private railcars, scheduling and expected availability of equipment or assets, repositioning options for assets, and other aspects. A planning horizon can be established to assist with management of a rail fleet on, for example, daily, weekly, monthly, and longer schedules. These aspects can be applied to, for example, direct assets to efficient demand points and minimize repositioning time while maximizing utilization. Such aspects can work with enterprises or sub-enterprises that have outlooks that have a single point of original or multiple points of origin, and can accommodate multiple destinations, with respect to the possible shipment routes.

A technique related to the above example of rail fleet optimization can include aspects directed toward the receipt and/or review of orders, updating input variables, checking asset or material availability, running an optimization, and transmitting or receiving optimized shipment plans.

Orders can be received electronically via a customer, shipper, or other entity's enterprise resource system. Alternatively, orders can be manually entered. Optimizations can be selected per order or for application to a group of orders to, for example, maximize expected revenue or minimize shipment costs. Once an order is received and/or entered, order details can be reviewed and/or updated. Orders can include details about shippers and receivers, such as operating days, unloading time windows, equipment restrictions, and so forth.

Input variables can be received, for example, via an enterprise resource system or order processing system. Input variables can include: car type, car capacity, commodity compatibility, freight rate/routes, Shipment revenue, transit time, private car charges—maintenance, mileage, repositioning charges (enterprise or other private equipment), equipment availability forecast, customer demand, fleet size, shipment planning horizon, order scheduling, storage locations, source locations, service level commitments, car allocation, empty miles, local service schedule, load/unload constraints, car spots, throughput capacity, operating days, labor hours, customer dwell time, turnaround time, commercial incentives, safety requirements, transit restrictions, maintenance schedules, storage (e.g., on-site, temporary at customer), and seasonality issues.

Routing can be included in input variables. Track, freight, and/or mileage rates can be included, and when applicable separate freight rates can be listed for different assets and/or asset providers. Freight rates and/or routes can be updated before optimization (or in anticipation of a subsequent optimization). Particular times associated with routes and entities related to those routes can be provided or inferred, and particular assets, material, or equipment can be barred from particular routes or locations based on constraints.

Railcars can be tracked along routes. Continuous monitoring can facilitate the use of most-current information during optimization. Estimated times of departure and arrival can be calculated, and in-transit information can be dynamically integrated to improve forecasting and planning accuracy.

Optimizations can be defined by users, provided with the optimization suite, and effected by other options. A history of prior optimizations can be maintained in the system, and various wizards, guides, or templates can be employed to develop optimizations. Various output results are available for review upon completion of the optimization, and, in embodiments, multiple optimizations can be toggled-between. In addition to monetary concerns, optimizations can maximize fulfillment as defined according to various shipper metrics.

After optimizations, a shipment plan can be generated in accordance with the optimizations. Varying levels of detail can be invoked in various views related to particular time periods and filters (e.g., for a particular customer, from a particular origin, and so forth). A recommended shipping schedule can identifies assets and routes to be employed. In addition to the shipping schedule, a repositioning schedule in support of the shipping schedule can be provided. Fulfillment summaries can be provided related to shipments.

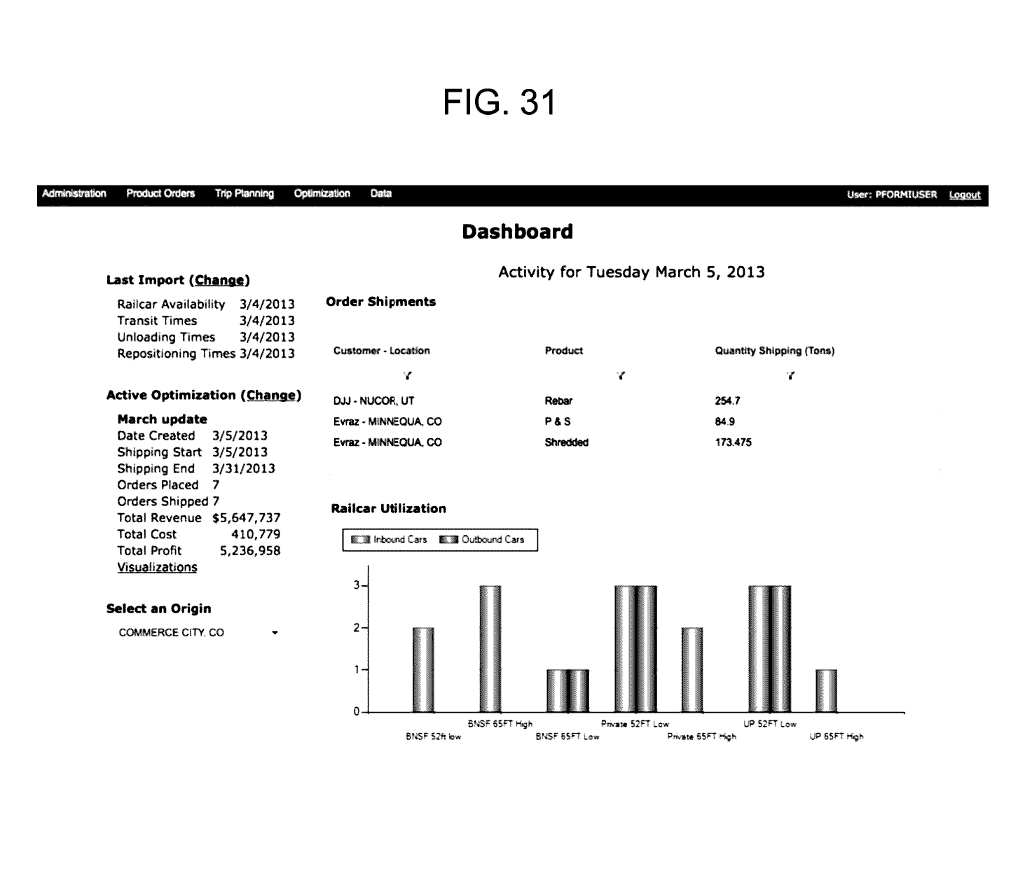

In embodiments, the system further comprises a “dashboard” interface that allows review of the orders and related aspects. Examples of such interfaces are provided in FIGS. 20 and 31. (Generally, “dashboard” refers to a single display screen that summarizes a set of data/information, typically in such a way for a user to relatively easily understand aspects or trends of the data/information.) Activity for time periods (e.g., current day, last week) can be shown in text or graphics (e.g., graphs of quantities shipped by product). Locations can also be included. A dashboard can include information about the last set of data imported or update times to identify the recentness of information displayed. Various metrics such as dates relating to the order, numbers of orders, revenues, costs, profits, et cetera can be included, and displayed with various visualizations. The dashboard can also be used to segregate information according to locations or entities (e.g., point of origin).

A dashboard can further provide information about the orders such as edit or delete capabilities, order identification, point of origin, customer location, product(s), remaining quantities (available to ship and/or currently un-shipped in order), product pricing, first shipping date, and last shipping date. The dashboard can enable application of limiting constraints to order such as freight payment constraints, minimum shipment amounts and timing, and groups of railcars to be employed.

Railcar groups can be defined using the dashboard, and can include details such as name, type, and minimum, maximum, or average capacity in cubic feet, weight, et cetera. Maintenance costs by day and/or mile can also be provided with respect to groups of rail cars. In embodiments, all railcars in a group can be identical. In alternative embodiments, railcar groups can include cars that share similar characteristics but are not identical. Various embodiments of both can coexist in a single system. Groupings can be created manually or automatically.

Abbreviations or shortcuts can be created for customers, destinations, and so forth. A dashboard can further include aspects related to routes between locations, including pricing associated with private/contracted rail and/or track rates. Further, transit, loading, and unloading times associated with orders or sub-orders can be entered into a dashboard to facilitate additional planning. The dashboard can display railcar (or other asset) availability by quantity, use, location, et cetera according to particular dates. A dashboard user can set defaults to control where specifics are not entered according to an order, customer, location, et cetera.

A dashboard can also be used to determine optimizations. Various optimizations can be defined and saved to be run based on the current conditions in an enterprise utilizing railcars (or other assets). The optimizations can determine shipping solutions based on the variables and other information that, for example, maximize revenue and/or utilization while minimizing cost and/or repositioning.

Finally, the dashboard can display final shipment information after optimization. Optimal shipping schedules can be generated on a by-order, daily, by-facility, and/or other bases. Optimized shipping plans can be shown for windows of time with or without filters to present a complete picture of all shipping occurring under an optimized schedule. A repositioning schedule can also be provided to show required repositioning based on the optimized solutions. The dashboard can further present post-shipment visualizations or graphics that can illustrate, for example, graphs of product ordered versus product shipped over time, product demand over time, railcar utilization over time, repositioning, and so forth.

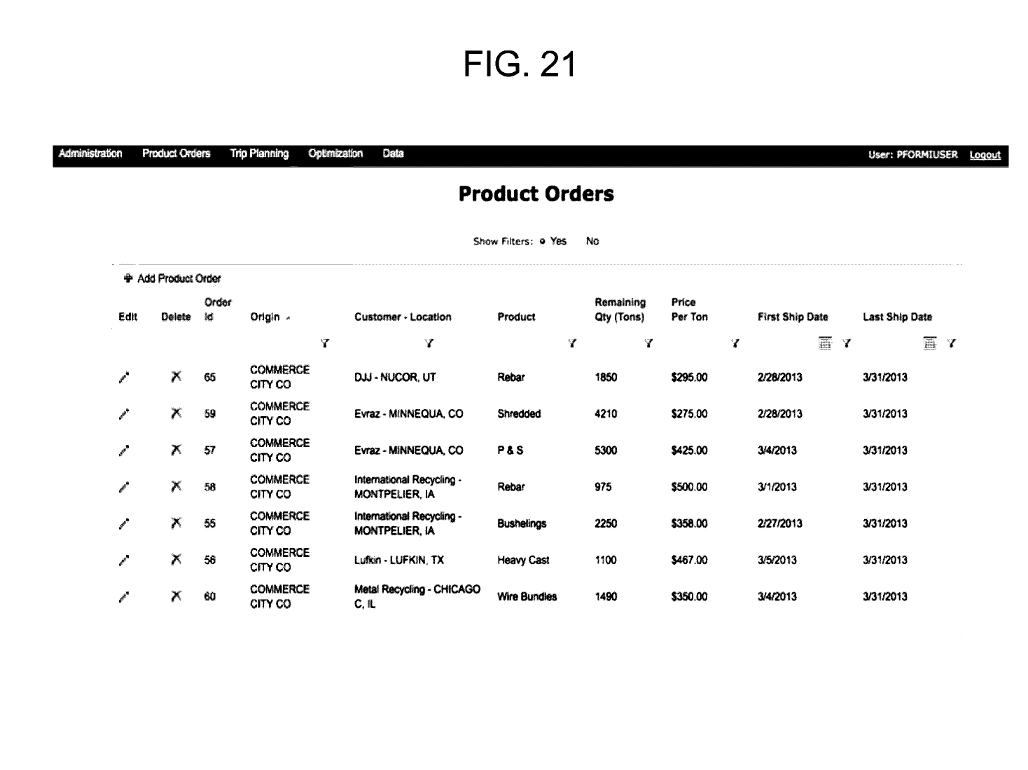

FIG. 21 illustrates an embodiment of a display screen of a dashboard summarizing product orders. As indicated, the display screen can include information about plural product orders, namely, for each order, one or more of information of product order origin, customer location, what product is included in the order, what quantity of that product remains in inventory, price per unit of product, first ship date, and last ship date.

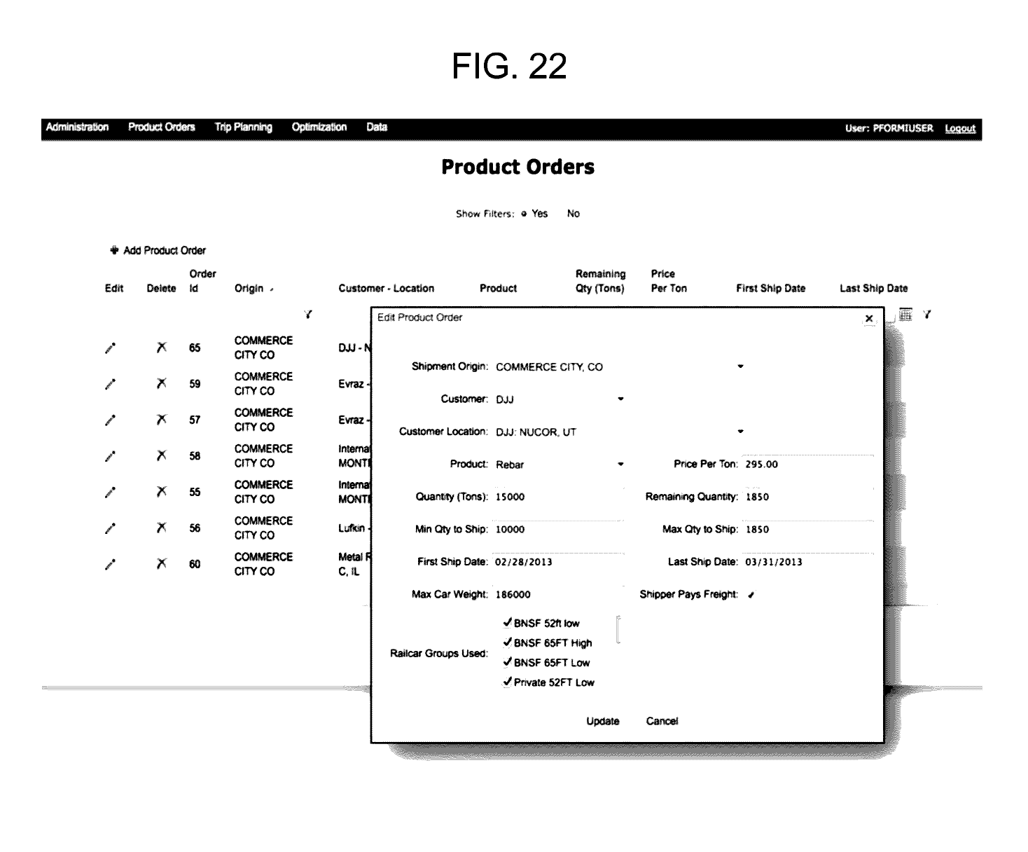

FIG. 22 illustrates an embodiment of a user interface display screen (a “pop up window”) for editing product orders. Specifically, the system may include functionality for a user to select a particular product order, and in response to user selection of a product order, the system displays the screen of FIG. 22 for a user to edit the order. Editing options may include changing one or more of: shipment origin; customer; customer location; product; quantity; minimum quantity to ship; first ship date; maximum asset weight (e.g., maximum allowable weight of a railcar); asset groups used (e.g., railcar groups used); price per unit of product; remaining quantity of product in inventory; maximum quantity to ship; last ship date; an option to indicate that the shipper pays freight; and/or the like.

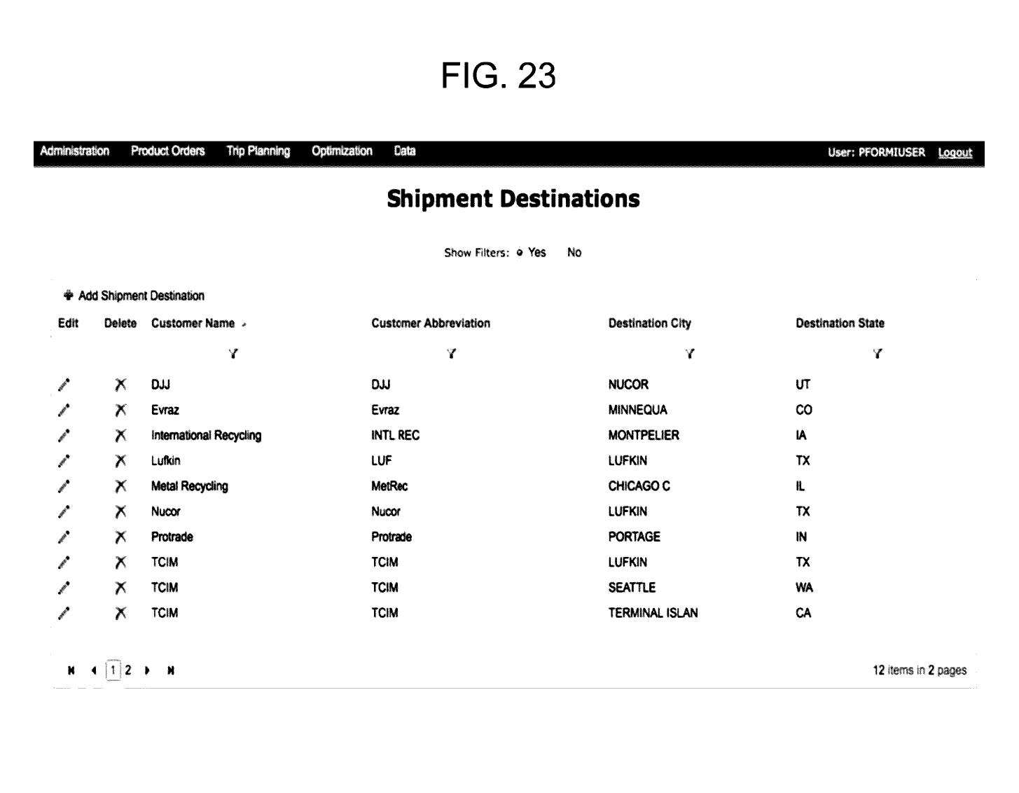

FIG. 23 illustrates an embodiment of a display screen of a dashboard summarizing shipment destinations (that is, destinations to which products will be shipped for fulfilling orders from customers). As indicated, the display screen can include information about plural shipment destinations, namely, for each shipment destination, information of one or more of customer name, customer abbreviation, destination city, destination state, destination country, and/or the like.

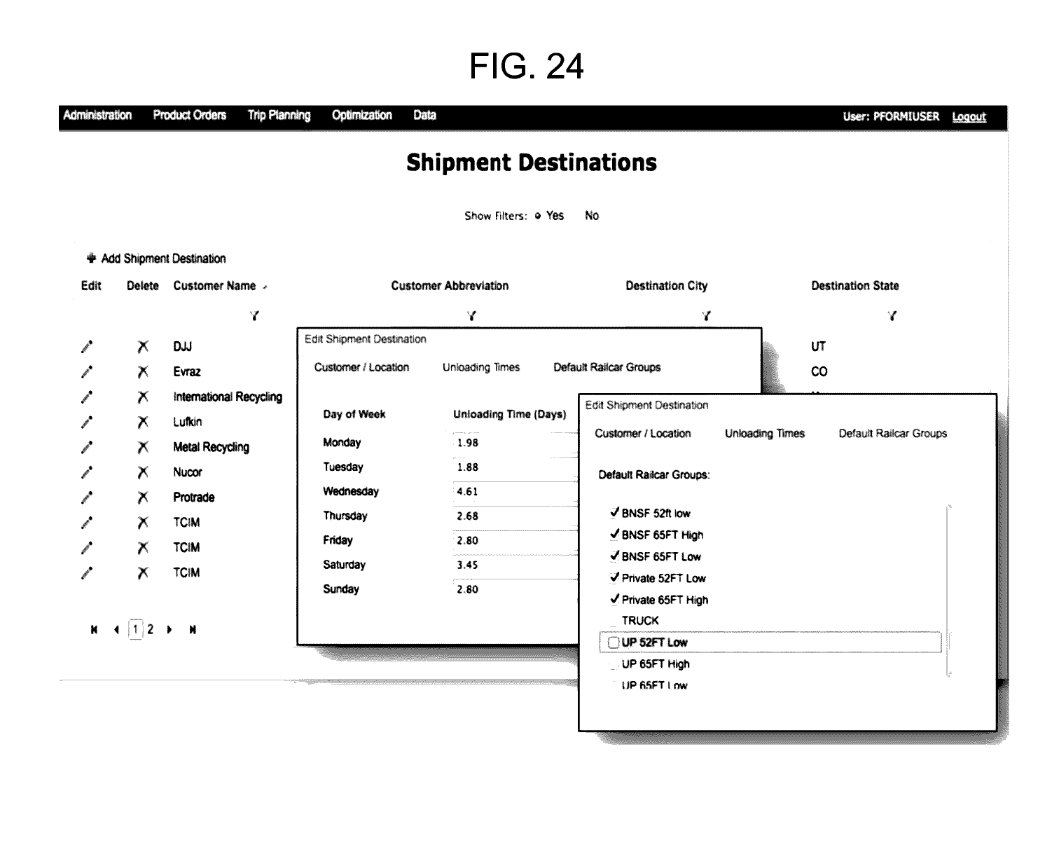

FIG. 24 illustrates an embodiment of a user interface display screen for editing shipment destinations. For example, the user interface may include options for a user to edit customer and/or location, unloading times, and setting asset groups (e.g., railcar groups for fulfilling orders).

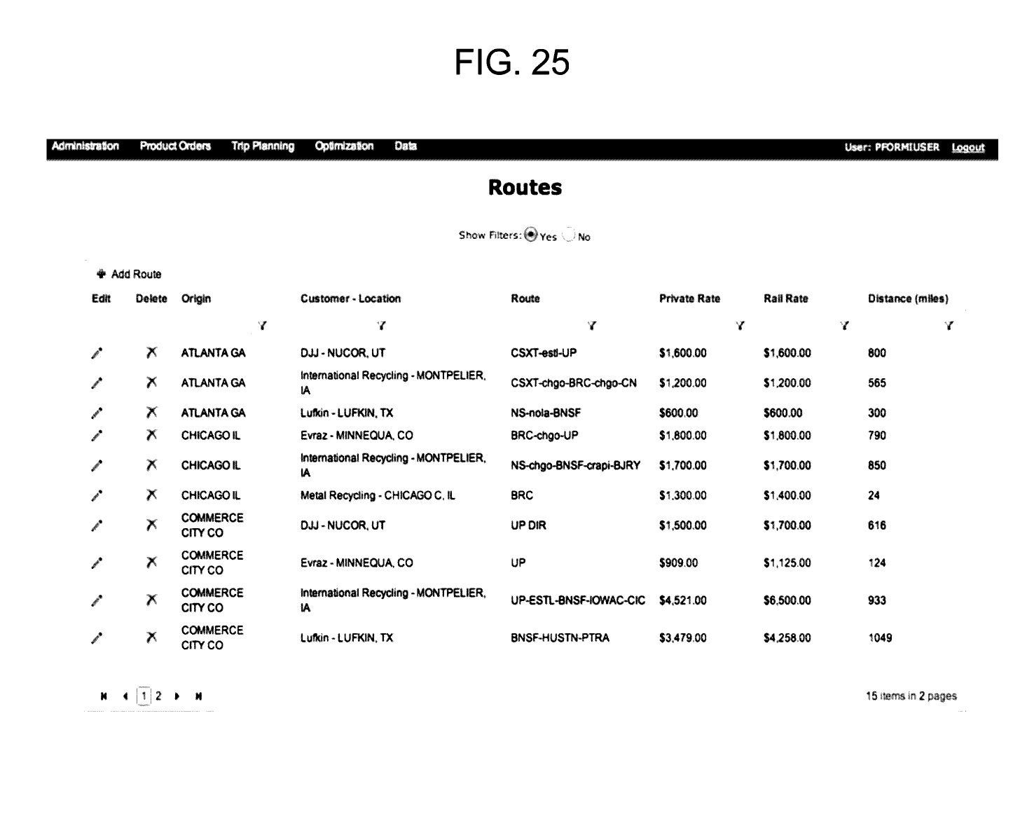

FIG. 25 illustrates an embodiment of a display screen of a dashboard summarizing routes (e.g., routes of product shipments). As indicated, the display screen can include information about plural routes, namely, for each route, information of one or more of origin, customer location, route name, shipping rates and/or rates to use the route, assets, etc., and a distance of the route.

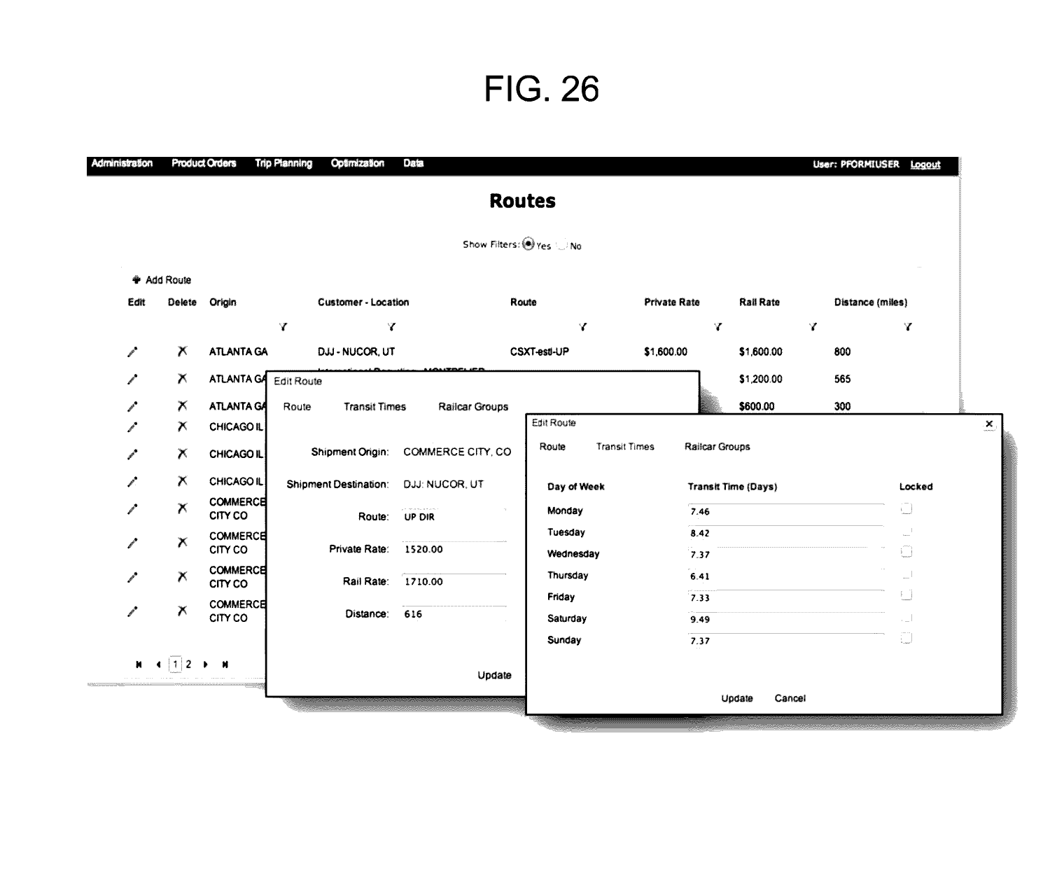

FIG. 26 illustrates an embodiment of a user interface display screen for editing route information. For example, the user interface may include options for a user to edit the route, transit times, and asset groups.

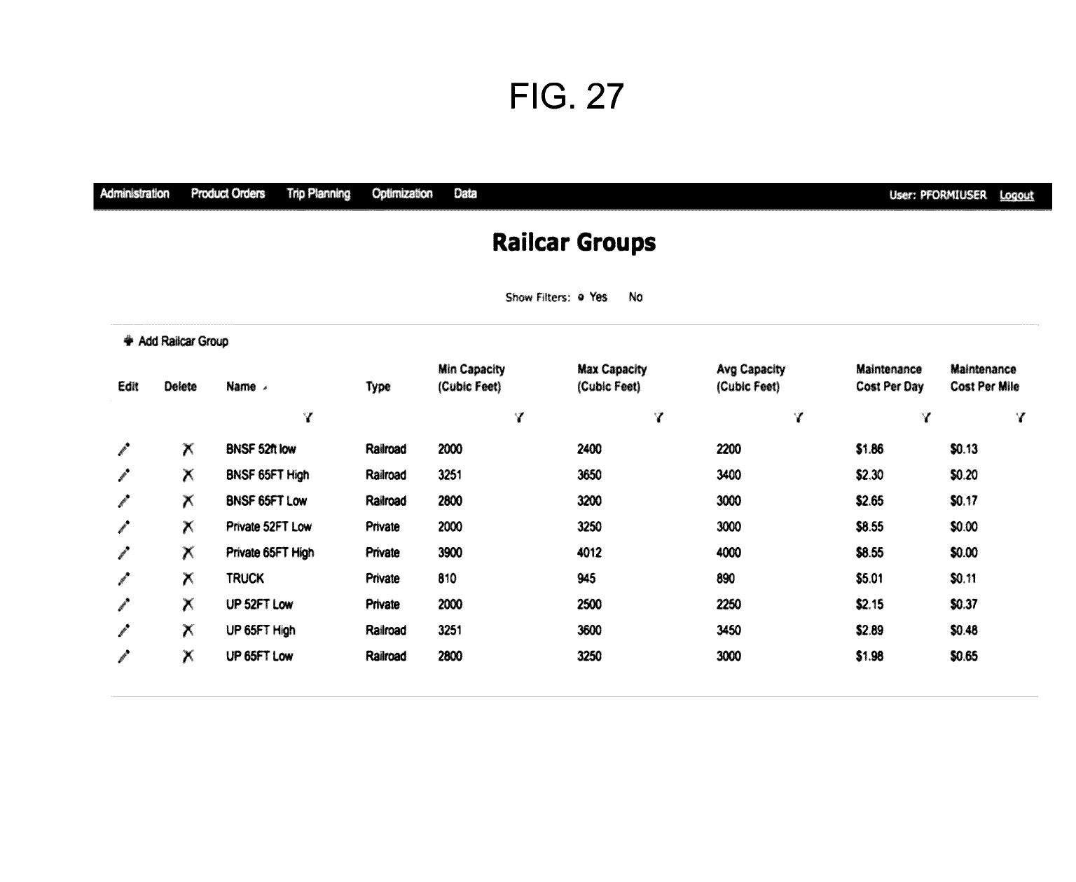

FIG. 27 illustrates an embodiment of a display screen of a dashboard summarizing asset groups (e.g., railcar groups). As indicated, the display screen can include information about plural asset groups, namely, for each asset group, information of one or more of group name, group type (e.g., mode of transportation used by the group), minimum capacity, maximum capacity, average capacity, maintenance cost per day, and maintenance cost per unit distance (e.g., mile or kilometer).

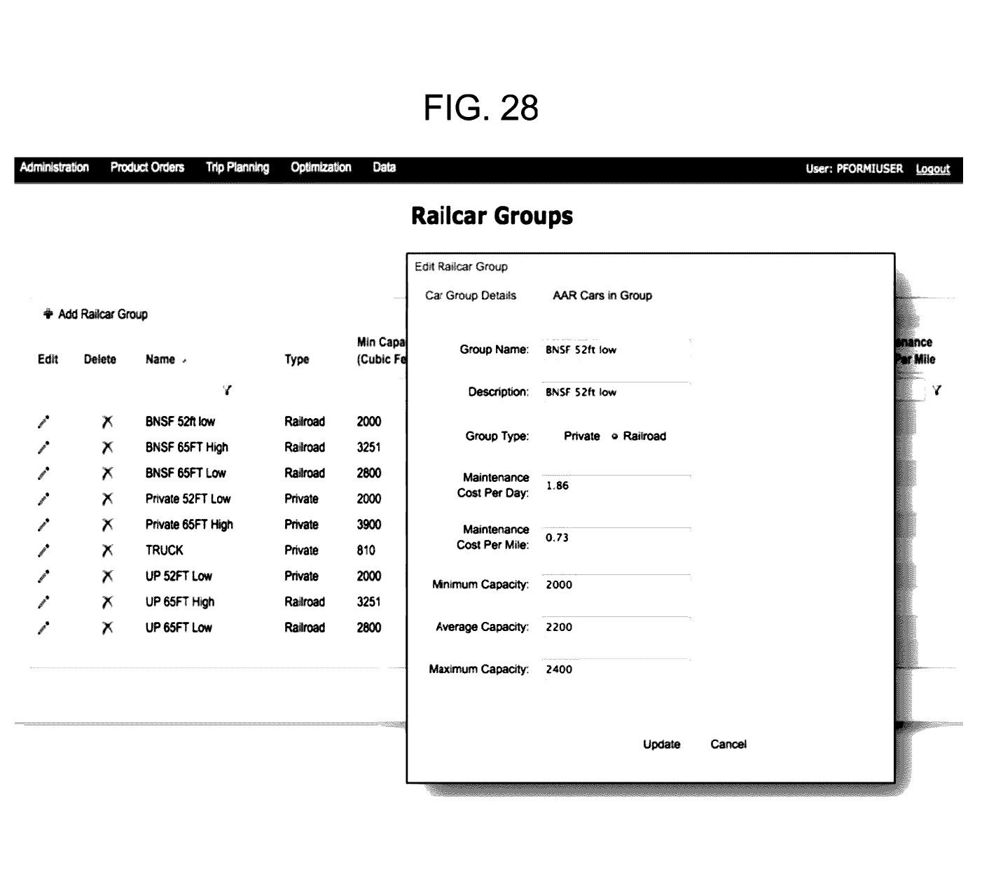

FIG. 28 illustrates an embodiment of a user interface display screen for editing asset group information. For example, the user interface may include options for a user to edit group details, and list designated assets within the group (e.g., assets belonging to a particular entity).

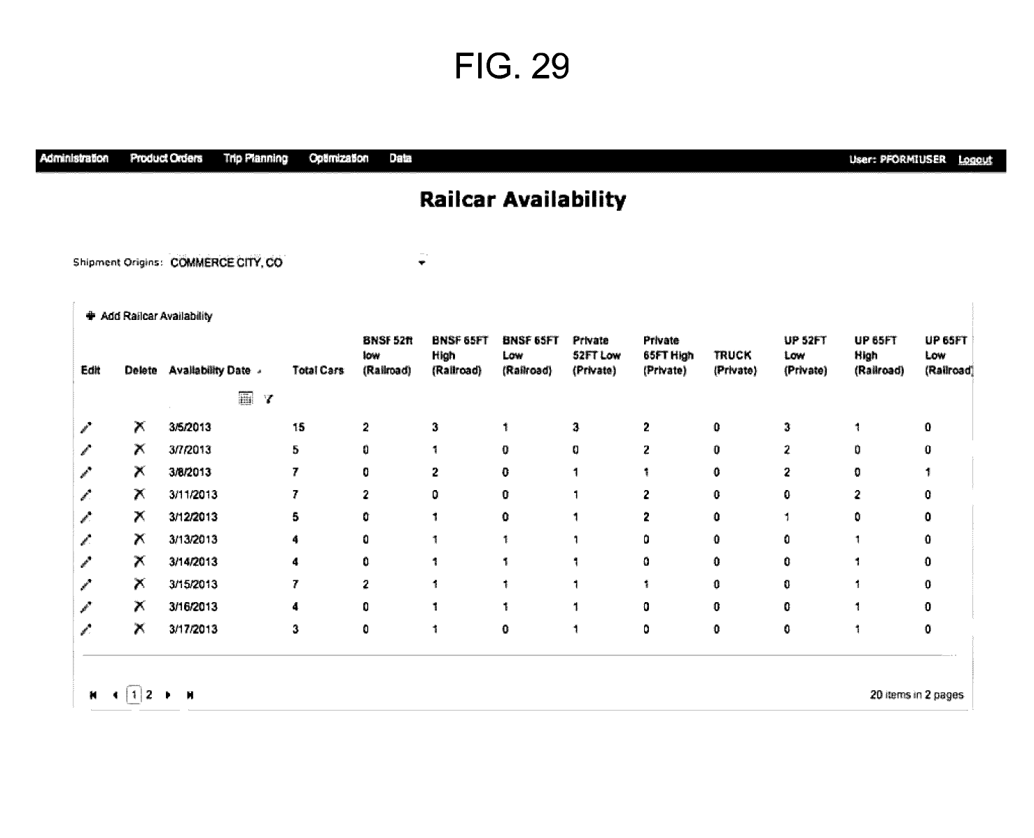

FIG. 29 illustrates an embodiment of a display screen of a dashboard summarizing asset availability (e.g., railcar availability). As indicated, the display screen can include information about the availability of plural assets, namely, for each asset, information of one or more of availability date, total assets, and group-specific information.

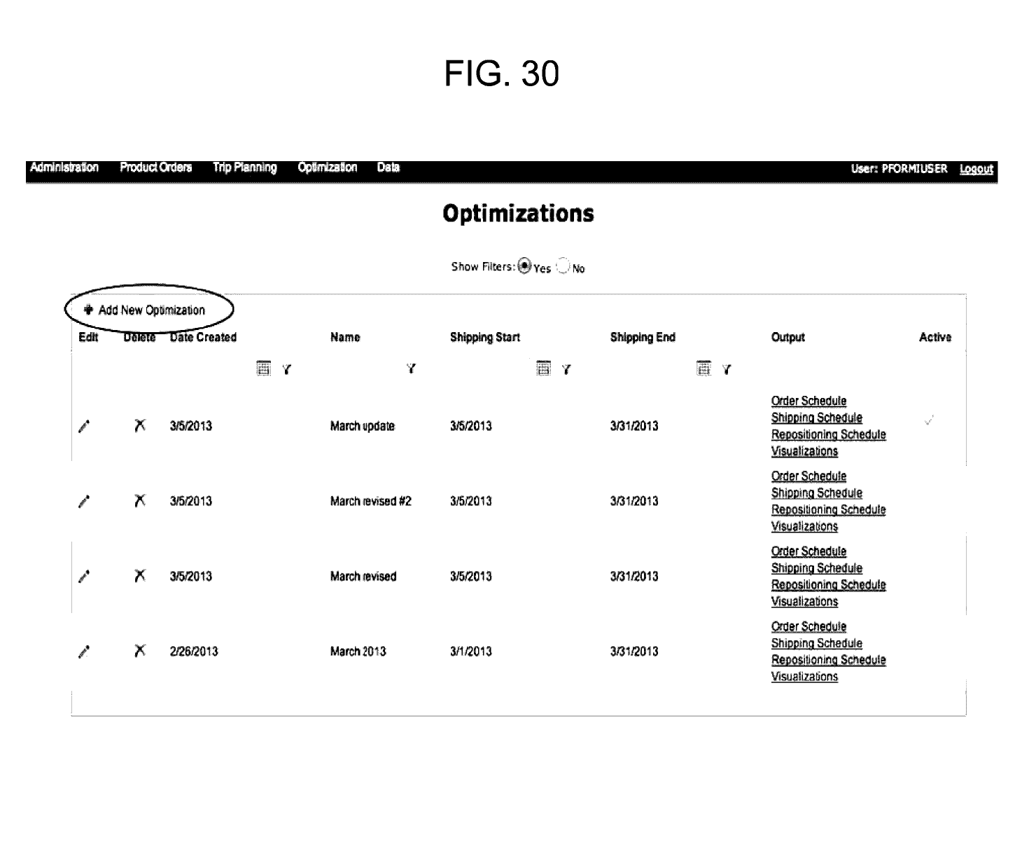

FIG. 30 illustrates an embodiment of a display screen of a dashboard summarizing “optimizations” (generally referring to plans for managing orders, e.g., products, assets, shipment, that are improved in some way over handling orders other than according to the plans). As indicated, the display screen can include information on one or more of creation date (of when a plan was created), name, shipping start and end, and options for output, such as an order schedule, a shipping schedule, a repositioning schedule, or visualizations (e.g., charts, graphs, etc. summarizing data).

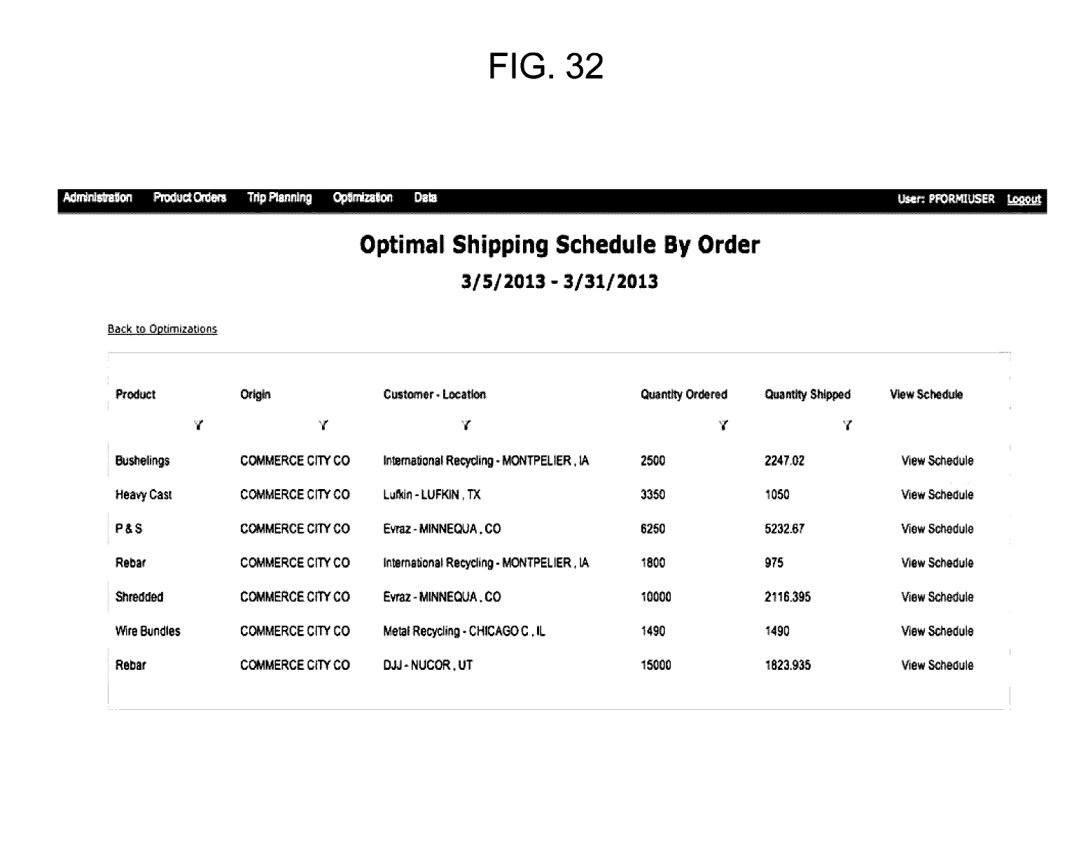

FIG. 32 illustrates an embodiment of a display screen of a dashboard summarizing a shipping schedule by order. (The shipping schedule may be according to an “optimal” plan.) As indicated, for each order, the display screen can include information on one or more of product, origin, customer and location, quantity of product ordered, quantity of product shipped, and an option to view a schedule.

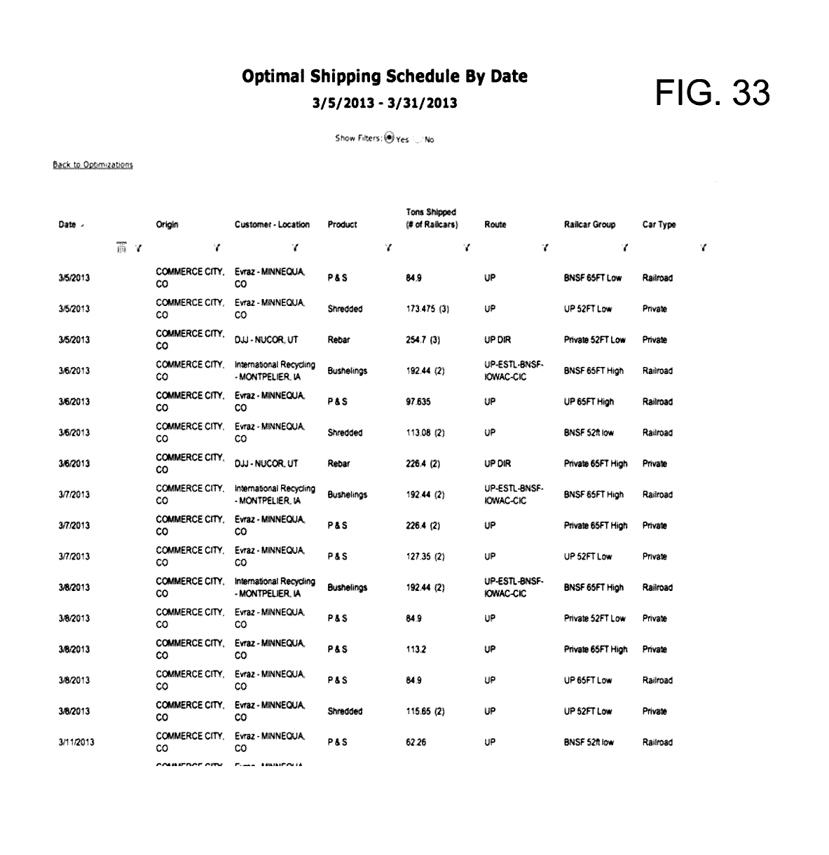

FIG. 33 illustrates an embodiment of a display screen of a dashboard summarizing a shipping schedule by date. As indicated, for each order, the display screen can include information on one or more of date, origin, customer and location, product, quantity shipped and number of assets used for shipping, route, asset group, and asset type.

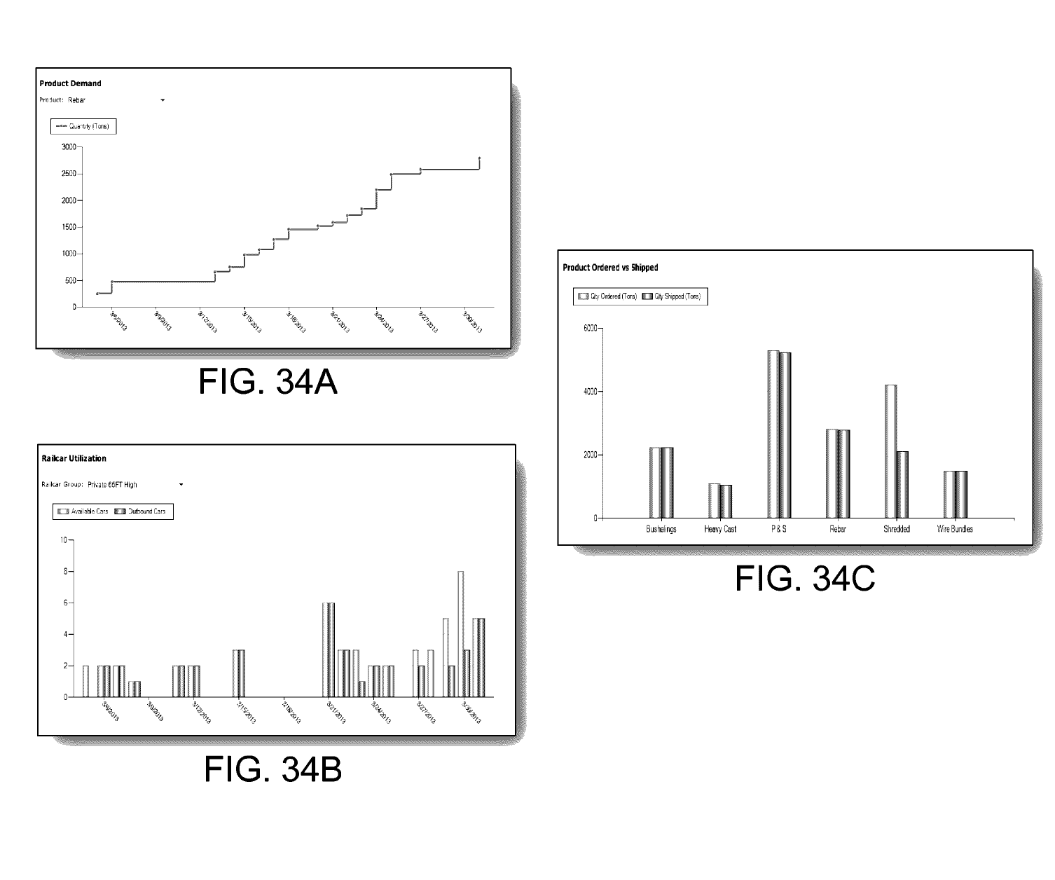

The system may be configured to generate display screens such as shown in FIGS. 34A, 34B, and 34C, which illustrate embodiments of display screens showing graphs that summarize data/information. For example, FIG. 34A shows a graph of product demand over time for a given product, where the display screen includes a user interface (e.g., drop down menu) for a user to select a product of interest. FIG. 34B shows a graph of asset utilization over time. FIG. 34C shows a graph contrasting product ordered versus product shipped.

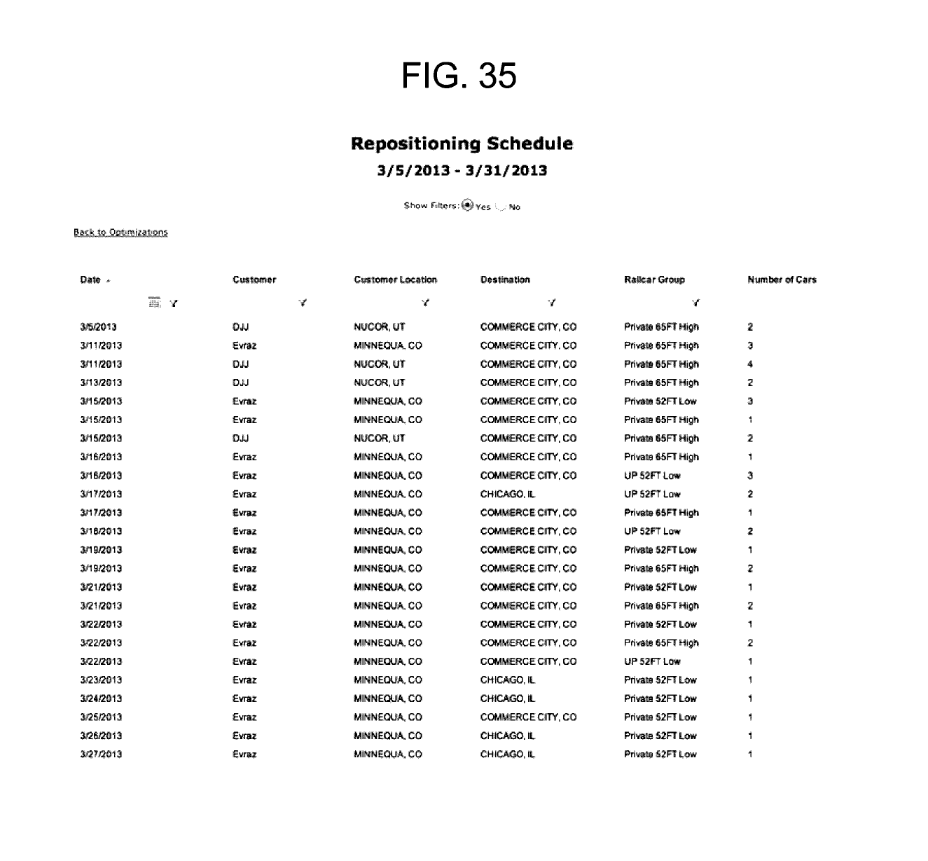

FIG. 35 illustrates an embodiment of a display screen of a dashboard summarizing a repositioning schedule for a given time period. As indicated, for each repositioning (e.g., repositioning of assets from one location to another), the display screen can include information on one or more of date, customer, customer location, destination, asset group designation, and number of assets in the group.

Another method may facilitate inventory and workflow management. The method may include various aspects using a controller, such as receiving one or more product locations of one or more products within a facility, receiving one or more asset locations of one or more assets within the facility, receiving an order for at least one of the one or more products, assigning at least a portion of the at least one of the one or more products to at least one of the one or more assets to complete the order, and scheduling a fulfillment of the order based one or more workflow times associated with one or more tasks. The one or more tasks may include one or more of receiving, inspecting, cleaning, repairing, maintaining, moving, loading, unloading, transferring, and testing of the one or more products or the one or more assets. A map of the facility may be generated that includes representations of the one or more products at the one or more product locations (the one or more assets at the one or more asset locations, and one or more locations associated with the order), and/or visually representing the map with respective visual characteristics on a display screen of a user device in operative communication with the controller. An order status update may be received that is based at least in part on the tasks. The map may be updated based on the order status update. A production schedule may be determined for the one or more products based on at least the fulfillment and the order, and/or releasing the at least one of the one or more assets for transport based on the fulfillment. One or more production schedules may be further based on a customer schedule. An order status update based on the one or more tasks may be received, and an alert may be given in response to the order status update.

The controller may receive a product inventory including one or more products at a facility, receive an asset inventory including one or more assets at the facility, receive a set of orders including one or more product orders, and one or more statuses associated respectively with the one or more product orders (wherein the statuses include location information describing at least one location associated with the one or more products and the one or more assets). The controller may provide a graphical representation of at least a map of the facility including the location information to be displayed on a user device, and may produce a notification based on the location information that prompts one or more tasks related to the set of orders. In one embodiment, the controller may modify the product inventory based on the set of orders, and schedule an inventory replenishment based on the set of orders. In alternative or complementary embodiments, the controller may calculate a total storage capacity of at least a subset of the asset inventory, and may calculate an available capacity of at least the subset of the asset inventory, wherein the inventory replenishment may be further based on at least one of the total capacity and the available capacity. In addition, the controller may calculate a fulfillment rate based on at least the set of orders, and/or to schedule a downtime associated with at least a portion of the facility based on the set of orders.

The system may include an enterprise resource planning system, a controller, and a user device. The enterprise resource planning system may schedule an order to be fulfilled from an inventory at a facility. The controller may be associated with the facility and may be communicatively linked to the enterprise resource planning system, and may allocate the inventory to a plurality of assets at the facility based at least in part on the order. The user device may be communicatively linked to the controller, and may receive from the facility management controller a workflow list based on the order. In addition, the workflow list may include at least one task that completes the order by causing a portion of the inventory for the order to ship to a customer, and/or at least one task that replenishes the inventory based on at least the order. The user device may transmit an update to the workflow list based on activity that modifies at least one of an order status or an inventory status, and/or the enterprise resource planning system may schedule a subsequent order based on a fulfillment time associated with the order. In addition, the controller may schedule repositioning of at least a portion of the inventory or at least one of the plurality of assets based on the order.

In another embodiment, a system comprises at least one controller configured to: receive a shipping schedule including a set of scheduled orders; receive a new order identifying at least one product to be shipped; identify one or more assets available to the new order; calculate at least one cost associated with the new order and the one or more assets available; select at least one of the one or more assets available to complete the new order based on the shipping schedule and the at least one cost; and add the new order to the shipping schedule.

In another embodiment, a method comprises processing, with at least one controller, a shipping schedule including a set of orders, and processing, with the at least one controller, an equipment availability matrix including a set of assets based on the shipping schedule. The method further comprises determining, with the at least one controller, one or more costs based on at least the set of orders and the set of assets. The method further comprises identifying, with the at least one controller, one or more possible shipping solutions associating one or more assets from the set of assets with at least one order from the set of orders to fulfill the set of orders in accordance with the shipping schedule. The method further comprises selecting, with the at least one controller, a shipping solution based at least on the one or more costs.

With reference to the drawings, like reference numerals designate identical or corresponding parts throughout the several views. However, the inclusion of like elements in different views does not mean a given embodiment necessarily includes such elements or that all embodiments of the invention include such elements.

In the specification and claims, reference will be made to a number of terms have the following meanings. The singular forms “a”, “an” and “the” include plural referents unless the context clearly dictates otherwise. Approximating language, as used herein throughout the specification and claims, may be applied to modify any quantitative representation that could permissibly vary without resulting in a change in the basic function to which it may be related. Accordingly, a value modified by a term such as “about” is not to be limited to the precise value specified. In some instances, the approximating language may correspond to the precision of an instrument for measuring the value. Similarly, “free” may be used in combination with a term, and may include an insubstantial number, or trace amounts, while still being considered free of the modified term. Moreover, unless specifically stated otherwise, any use of the terms “first,” “second,” etc., do not denote any order or importance, but rather the terms “first,” “second,” etc., may distinguish one element from another.

This written description uses examples to disclose the invention, including the best mode, and also to enable one of ordinary skill in the art to practice the invention, including making and using any devices or systems and performing any incorporated methods. The embodiments described herein may be examples of articles, systems, and methods having elements corresponding to the elements of the invention recited in the claims. This written description may enable those of ordinary skill in the art to make and use embodiments having alternative elements that likewise correspond to the elements of the invention recited in the claims. The scope of the invention thus includes articles, systems and methods that do not differ from the literal language of the claims, and further includes other articles, systems and methods with insubstantial differences from the literal language of the claims. While only certain features and embodiments have been illustrated and described herein, many modifications and changes may occur to one of ordinary skill in the relevant art. The appended claims cover all such modifications and changes.

What is claimed is:

1. A device for transmitting a network routing procedure based on an optimization process, the device comprising:
a memory configured to store instructions; and
a processor configured to execute the instructions to:
create an array of values based on information associated with a plurality of devices;
receive information identifying one or more deliverables for routing from a first network address to a second network address in a network;
parse scheduling information and the information identifying the one or more deliverables;
calculate, based on parsing the scheduling information and the information identifying the one or more deliverables, a value associated with routing the one or more deliverables;
use, based on calculating the value associated with routing the one or more deliverables, the array of values to implement the optimization process,
the optimization process producing a recommended network routing procedure; and
transmit, based on implementing the optimization process, the recommended network routing procedure,
the transmitted recommended network routing procedure being provided, for presentation, on another device.

2. The device of claim 1, where the array of values is created using at least one of:
current location information,
forecasted location information, or
expected availability information.

3. The device of claim 1, where the processor is further configured to:
receive information associated with at least one of forecast information or cost information; and
use the received information, associated with the at least one of the forecast information or the cost information, to calculate the optimization process.

4. The device of claim 1, where the processor is further configured to:
modify the scheduling information based on receiving the information identifying one or more deliverables.

5. The device of claim 1, where the processor is further configured to:
provide, for presentation, information associated with the one or more deliverables,
the information associated with the one or more deliverables being provided for presentation in a first display, and
additional information, associated with the one or more deliverables, being provided for presentation in a second display based on a selection operation.

6. The device of claim 1, where the processor is further configured to:
receive information associated with a movement of the one or more deliverables in the network;
compare the received information associated with the movement to a predetermined criterion; and
transmit, based on the comparing, result information.

7. The device of claim 1, where
the optimization process analyzes revenue information and cost information, and
the optimization process uses the revenue information and the cost information to determine a recommended quantity associated with the one or more deliverables and a recommended type of the one or more deliverables.

8. A method for transmitting a network routing procedure based on an optimization process, the method comprising:
creating, by a device, an array of values based on information associated with a plurality of devices;
receiving, by the device, information identifying one or more deliverables for routing from a first network address to a second network address in a network;
parsing, by the device, scheduling information and the information identifying the one or more deliverables;
calculating, by the device and based on parsing the scheduling information and the information identifying the one or more deliverables, a value associated with routing the one or more deliverables;
using, by the device and based on calculating the value associated with routing the one or more deliverables, the array of values to implement the optimization process,
the optimization process producing a recommended network routing procedure; and
transmitting, by the device and based on implementing the optimization process, the recommended network routing procedure,
the transmitted recommended network routing procedure being provided, for presentation, on another device.

9. The method of claim 8, where the array of values is created using at least one of:
current location information,
forecasted location information, or
expected availability information.

10. The method of claim 8, further comprising:
receiving information associated with at least one of forecast information or cost information; and
using the received information, associated with the at least one of the forecast information or the cost information, to calculate the optimization process.

11. The method of claim 8, further comprising:
modifying the scheduling information based on receiving the information identifying one or more deliverables.

12. The method of claim 8, further comprising:
providing, for presentation, information associated with the one or more deliverables,
the information associated with the one or more deliverables being provided for presentation in a first display, and
additional information, associated with the one or more deliverables, being provided for presentation in a second display based on a selection operation.

13. The method of claim 8, further comprising:
receiving information associated with a movement of the one or more deliverables in the network;
comparing the received information associated with the movement to a predetermined criterion; and
transmitting, based on the comparing, result information.

14. The method of claim 8, where
the optimization process analyzes revenue information and cost information, and
the optimization process uses the revenue information and the cost information to determine a recommended quantity associated with the one or more deliverables and a recommended type of the one or more deliverables.

15. A non-transitory computer readable medium storing instructions for transmitting a network routing procedure based on an optimization process, the instructions comprising:
one or more instructions which, when executed by a processor of a device, cause the processor to:
create an array of values based on information associated with a plurality of devices;
receive information identifying one or more deliverables for routing from a first network address to a second network address in a network;
parse scheduling information and the information identifying the one or more deliverables;
calculate, based on parsing the scheduling information and the information identifying the one or more deliverables, a value associated with routing the one or more deliverables;
use, based on calculating the value associated with routing the one or more deliverables, the array of values to implement the optimization process,
the optimization process producing a recommended network routing procedure; and
transmit, based on implementing the optimization process, the recommended network routing procedure,
the transmitted recommended network routing procedure being provided, for presentation, on another device.

16. The non-transitory computer readable medium of claim 15, where the instructions further include:
one or more instructions to receive information associated with at least one of forecast information or cost information; and
one or more instructions to use the received information, associated with the at least one of the forecast information or the cost information, to calculate the optimization process.

17. The non-transitory computer readable medium of claim 15, where the instructions further include:
one or more instructions to modify the scheduling information based on receiving the information identifying one or more deliverables.

18. The non-transitory computer readable medium of claim 15, where the instructions further include:
one or more instructions to provide, for presentation, information associated with the one or more deliverables,
the information associated with the one or more deliverables being provided for presentation in a first display, and
additional information, associated with the one or more deliverables, being provided for presentation in a second display based on a selection operation.

19. The non-transitory computer readable medium of claim 15, where the instructions further include:
one or more instructions to receive information associated with a movement of the one or more deliverables in the network;
one or more instructions to compare the received information associated with the movement to a predetermined criterion; and
one or more instructions to transmit, based on the comparing, result information.

20. The non-transitory computer readable medium of claim 15, where
the optimization process analyzes revenue information and cost information, and
the optimization process uses the revenue information and the cost information to determine a recommended quantity associated with the one or more deliverables and a recommended type of the one or more deliverables.
